(19) United States
(12) Patent Application Publication
(10) Pub. No.: US 2008/0318781 A1
(43) Pub. Date: Dec. 25, 2008

(54) Method of Controlling Weeds

(76) Inventors: Cyrill Zagar, Mannheim (DE); Dan E. Westberg, Cary, NC (US); Rex Liebl, Raleigh, NC (US)

Correspondence Address: BRINKS, HOFER, GILSON & LIONE, 2801 SLATER ROAD, SUITE 120, MORRISVILLE, NC, 27560, US

(21) Appl. No.: 11/996,986

(22) PCT Filed: Aug. 1, 2006
(86) PCT No.: PCT/EP06/07617

§ 371 Date: Feb. 14, 2008

Related U.S. Application Data
(60) Provisional application No. 60/703,872, filed on Aug. 1, 2005.

(51) Int. Cl. A01N 43/54; A01P 13/00

(52) U.S. Cl. 504/136; 504/243

(57) ABSTRACT

The present invention relates to the use of 3-phenyluracils of formula (I) wherein the variables R¹ to R⁷ are as defined in the description, optionally in combination with one or more other herbicides B and/or one or more safeners C for controlling weeds in soybeans, cotton, canola, flax, lentil, rice, sugar beet, sunflowers, tobacco, wheat and corn.

The present invention relates to a method of controlling weeds in crops selected from the group consisting of soybeans, cotton, canola, flax, lentil, rice, sugar beet, sunflower, tobacco, wheat and corn.

Weed control in row crops such as soybean, cotton, canola, flax, lentil, rice, sugar beet, sunflower, tobacco, wheat, or corn, is of great economic importance. Ideally, a herbicide treatment should be both safe in the crop and provide season-long control of all economically relevant weeds. In practice however, weed regrowth occurs rapidly and sequential treatments are required. This is particularly the case for glyphosate which is widely used in glyphosate resistant crop varieties. Providing long-term weed control in crops which is superior to control by glyphosate or other known herbicides is thus commercially desirable.

Phenyluracils are known to be useful herbicides. The use of herbicidal phenyluracils as desiccants and/or defoliants is disclosed in WO 01/83459. Furthermore, it is known from WO 03/24221 that combinations comprising phenyluracils of formula I

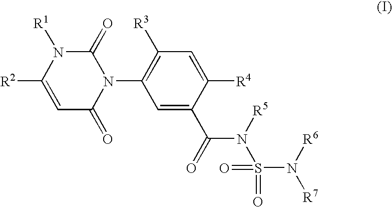

in which the variables R¹-R⁷ are as defined below:
R¹ is methyl or NH₂;
R² is C₁-C₂-haloalkyl;
R³ is hydrogen or halogen;
R⁴ is halogen or cyano;
R⁵ is hydrogen, cyano, C₁-C₆-alkyl, C₁-C₆-alkoxy, C₁-C₄-alkoxy-C₁-C₄-alkyl, C₃-C₇-cycloalkyl, C₃-C₆-alkenyl, C₃-C₆-alkynyl or benzyl which is unsubstituted or substituted by halogen or alkyl;
R⁶, R⁷ independently of one another are hydrogen, C₁-C₆-alkyl, C₁-C₆-alkoxy, C₃-C₆-alkenyl, C₃-C₆-alkynyl, C₃-C₇-cycloalkyl, C₃-C₇-cycloalkenyl, phenyl or benzyl, where each of the 8 abovementioned substituents is unsubstituted or may be substituted by 1 to 6 halogen atoms and/or by one, two or three groups selected from: OH, NH₂, CN, CONH₂, C₁-C₄-alkoxy, C₁-C₄-haloalkoxy, C₁-C₄-alkylthio, C₁-C₄-haloalkylthio, C₁-C₄-alkylsulfonyl, C₁-C₄-haloalkylsulfonyl, C₁-C₄-alkylamino, di(C₁-C₄-alkyl)amino, formyl, C₁-C₄-alkylcarbonyl, C₁-C₄-alkoxycarbonyl, C₁-C₄-alkylaminocarbonyl, di(C₁-C₄-alkyl)aminocarbonyl, C₃-C₇-cycloalkyl, phenyl and benzyl; or
R⁶, R⁷ together with the nitrogen atom form a 3-, 4-, 5-, 6- or 7-membered saturated or unsaturated nitrogen heterocycle which may be substituted by 1 to 6 methyl groups and which may contain 1 or 2 further heteroatoms selected from the group consisting of nitrogen, oxygen and sulfur as ring members,
   or their agriculturally acceptable salts, and other herbicides including glyphosate and/or certain safeners exhibit synergistically enhanced activity. WO 04/080183 discloses combinations of said phenyluracils with certain other herbicides having increased herbicidal activity and improved compatibility with useful plants. WO 2005/013696 discloses a method of controlling undesirable plant growth in pest-resistant and/or fungus-resistant transgenic useful plant crops which comprises applying at least one herbicide selected from the class of HPPD inhibitors in a herbicidally effective amount to the transgenic useful plant crops or to the locus thereof.

Surprisingly, it has now been found that phenyluracils or agriculturally acceptable salts thereof, optionally in combination with at least one other herbicide and/or optionally in combination with at least one safener effectively provide weed control in row crops, such as soybean, cotton, canola, flax, lentil, rice, sugar beet, sunflower, tobacco, wheat, or corn without damage to the crop, in particular when applied early pre-plant (i.e., up to 60 days prior to planting) up to pre-emergence (i.e., after planting but prior to crop emergence), or when applied post directed.

The present invention therefore relates to a method of controlling weeds in row crops, in particular in crops selected from the group consisting of soybeans, cotton, canola, flax, lentil, rice, sugar beet, sunflower, tobacco, wheat and corn which comprises allowing an herbicidally effective amount of a 3-phenyluracil of formula I (component A)

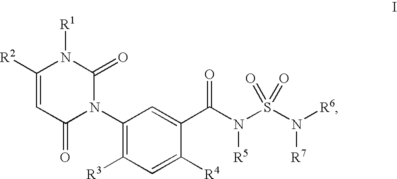

wherein the variables R¹ to R⁷ are as defined below:
R¹ is methyl or NH₂;
R² is C₁-C₂-haloalkyl;
R³ is hydrogen or halogen;
R⁴ is halogen or cyano;
R⁵ is hydrogen or C₁-C₆-alkyl;
R⁶, R⁷ independently of one another are hydrogen, C₁-C₆-alkyl, C₁-C₆-alkoxy, C₃-C₆-alkenyl, C₃-C₆-alkynyl, C₃-C₇-cycloalkyl, C₃-C₇-cycloalkenyl, phenyl or benzyl;
   or an agriculturally acceptable salt thereof to act on the crops or weeds or their habitat.

Habitat means the living space of the plants.

The organic moieties mentioned in the definition of the substituents R², R⁵, R⁶, R⁷ in formula I are—like the term halogen—collective terms for individual enumerations of the individual group members. All hydrocarbon chains, i.e. all alkyl, haloalkyl, cycloalkyl, alkoxy, cycloalkenyl, alkenyl and alkynyl groups can be straight-chain or branched, the prefix Cₙ-Cₘ denoting in each case the possible number of carbon atoms in the group. Halogenated substituents preferably carry one, two, three, four or five identical or different halogen atoms. The term halogen denotes in each case fluorine, chlorine, bromine or iodine.

Examples of such meanings are:
C₁-C₄-alkyl: CH₃, C₂H₅, n-propyl, CH(CH₃)₂, n-butyl, CH(CH₃)—C₂H₅, CH₂—CH(CH₃)₂ and C(CH₃)₃;
C₁-C₆-alkyl: C₁-C₄-alkyl as mentioned above, and also, for example, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl or 1-ethyl-2-methylpropyl, preferably methyl, ethyl, n-propyl, 1-methylethyl, n-butyl, 1,1-dimethylethyl, n-pentyl or n-hexyl;
C₁-C₂-haloalkyl: a methyl or ethyl radical, which is partially or fully substituted by fluorine, chlorine, bromine and/or iodine, for example CH₂F, CHF₂, CF₃, CH₂Cl, dichloromethyl, trichloromethyl, chlorofluormethyl, dichlorofluoromethyl, chlorodifluoromethyl, 2-fluoroethyl, 2-chloroethyl, 2-brom-oethyl, 2-iodoethyl, 2,2-difluoroethyl, 2,2,2-trifluoroethyl, 2-chloro-2-fluor-oethyl, 2-chloro-2,2-difluoroethyl, 2,2-dichloro-2-fluoroethyl, 2,2,2-tri-chloroethyl, C₂F₅;
C₁-C₄-alkoxy: OCH₃, OC₂H₅, n-propoxy, OCH(CH₃)₂, n-butoxy, OCH(CH₃)C₂H₅, OCH₂—CH(CH₃)₂ or OC(CH₃)₃, preferably OCH₃, OC₂H₅ or OCH(CH₃)₂;
C₁-C₆-alkoxy: a C₁-C₄-alkoxy radical as mentioned above, and also, for example pentoxy, 1-methylbutoxy, 2-methylbutoxy, 3-methoxylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy and 1-ethyl-2-methylpropoxy;
C₃-C₆-alkenyl: prop-1-en-1-yl, allyl, 1-methylethenyl, 1-buten-1-yl, 1-buten-2-yl, 1-buten-3-yl, 2-buten-1-yl, 1-methylprop-1-en-1-yl, 2-methylprop-1-en-1-yl, 1-methylprop-2-en-1-yl, 2-methylprop-2-en-1-yl, n-penten-1-yl, n-penten-2-yl, n-penten-3-yl, n-penten-4-yl, 1-methylbut-1-en-1-yl, 2-methylbut-1-en-1-yl, 3-methylbut-1-en-1-yl, 1-methylbut-2-en-1-yl, 2-methylbut-2-en-1-yl, 3-methylbut-2-en-1-yl, 1-methylbut-3-en-1-yl, 2-methylbut-3-en-1-yl, 3-methylbut-3-en-1-yl, 1,1-dimethylprop-2-en-1-yl, 1,2-dimethylprop-1-en-1-yl, 1,2-dimethylprop-2-en-1-yl, 1-ethylprop-1-en-2-yl, 1-ethylprop-2-en-1-yl, n-hex-1-en-1-yl, n-hex-2-en-1-yl, n-hex-3-en-1-yl, n-hex-4-en-1-yl, n-hex-5-en-1-yl, 1-methylpent-1-en-1-yl, 2-methylpent-1-en-1-yl, 3-methylpent-1-en-1-yl, 4-methylpent-1-en-1-yl, 1-methylpent-2-en-1-yl, 2-methylpent-2-en-1-yl, 3-methylpent-2-en-1-yl, 4-methylpent-2-en-1-yl, 1-methylpent-3-en-1-yl, 2-methylpent-3-en-1-yl, 3-methylpent-3-en-1-yl, 4-methylpent-3-en-1-yl, 1-methylpent-4-en-1-yl, 2-methylpent-4-en-1-yl, 3-methylpent-4-en-1-yl, 4-methylpent-4-en-1-yl, 1,1-dimethylbut-2-en-1-yl, 1,1-dimethylbut-3-en-1-yl, 1,2-dimethylbut-1-en-1-yl, 1,2-dimethylbut-2-en-1-yl, 1,2-dimethylbut-3-en-1-yl, 1,3-dimethylbut-1-en-1-yl, 1,3-dimethylbut-2-en-1-yl, 1,3-dimethylbut-3-en-1-yl, 2,2-dimethylbut-3-en-1-yl, 2,3-dimethylbut-1-en-1-yl, 2,3-dimethylbut-2-en-1-yl, 2,3-dimethylbut-3-en-1-yl, 3,3-dimethylbut-1-en-1-yl, 3,3-dimethylbut-2-en-1-yl, 1-ethylbut-1-en-1-yl, 1-ethylbut-2-en-1-yl, 1-ethylbut-3-en-1-yl, 2-ethylbut-1-en-1-yl, 2-ethylbut-2-en-1-yl, 2-ethylbut-3-en-1-yl, 1,1,2-trimethylprop-2-en-1-yl, 1-ethyl-1-methylprop-2-en-1-yl, 1-ethyl-2-methylprop-1-en-1-yl or 1-ethyl-2-methylprop-2-en-1-yl;
C₃-C₆-alkynyl: prop-1-yn-1-yl, prop-2-yn-1-yl, n-but-1-yn-1-yl, n-but-1-yn-3-yl, n-but-1-yn-4-yl, n-but-2-yn-1-yl, n-pent-1-yn-1-yl, n-pent-1-yn-3-yl, n-pent-1-yn-4-yl, n-pent-1-yn-5-yl, n-pent-2-yn-1-yl, n-pent-2-yn-4-yl, n-pent-2-yn-5-yl, 3-methylbut-1-yn-3-yl, 3-methylbut-1-yn-4-yl, n-hex-1-yn-1-yl, n-hex-1-yn-3-yl, n-hex-1-yn-4-yl, n-hex-1-yn-5-yl, n-hex-1-yn-6-yl, n-hex-2-yn-1-yl, n-hex-2-yn-4-yl, n-hex-2-yn-5-yl, n-hex-2-yn-6-yl, n-hex-3-yn-1-yl, n-hex-3-yn-2-yl, 3-methylpent-1-yn-1-yl, 3-methylpent-1-yn-3-yl, 3-methylpent-1-yn-4-yl, 3-methylpent-1-yn-5-yl, 4-methylpent-1-yn-1-yl, 4-methylpent-2-yn-4-yl or 4-methylpent-2-yn-5-yl, preferably prop-2-yn-1-yl;
C₃-C₇-cycloalkyl: a monocyclic saturated hydrocarbon ring having 3 to 7 ring members, such as cyclopropyl, cyclobutyl, cyclopentyl, cyclohexyl or cycloheptyl;
C₃-C₇-cycloalkenyl: monocyclic unsaturated hydrocarbon ring having 3 to 7 ring members, such as cycloprop-1-enyl, cycloprop-2-enyl, cyclobut-1-enyl, cyclobut-2-enyl, cyclobut-1,3-dienyl, cyclopent-1-enyl, cyclopent-2-enyl, cyclopent-3-enyl, cyclopent-2,4-dienyl, cyclohex-1-enyl, cyclohex-2-enyl, cyclohex-3-enyl; cyclohex-1,3-dienyl, cyclohex-1,5-dienyl, cyclohex-2,4-dienyl, or cyclohex-2,5-dienyl. One or more 3-phenyluracils may be used.

Among the 3-phenyluracils of formula I, preference is given to those wherein the variables R¹ to R⁷ independently of one another, have the meanings given below:
R¹ is methyl or NH₂;
R² is trifluoromethyl;
R³ is hydrogen, fluorine or chlorine, in particular fluorine;
R⁴ is halogen or cyano, in particular chlorine or cyano;
R⁵ is hydrogen;
R⁶, R⁷ independently of one another are hydrogen or C₁-C₆-alkyl.

R⁶ and R⁷ are in particular identical or different C₁-C₆-alkyl radicals.

A particularly preferred embodiment of the invention comprises the use of at least one 3-phenyluracil I in which the variables R¹ to R⁷ in formula I have the following meanings (hereinbelow also referred to as phenyluracils Ia):

R¹ is methyl;
R² is trifluoromethyl;
R³ is fluorine;
R⁴ is chlorine;
R⁵ is hydrogen;
R⁶, R⁷ independently of one another are C₁-C₆-alkyl.

Another particularly preferred embodiment of the invention comprises the use at least one 3-phenyluracil I in which the variables R¹ to R⁷ in formula I have the meanings below (hereinbelow also referred to as phenyluracils Ib):

### R¹ is NH₂;

R² is trifluoromethyl;
R³ is fluorine;
R⁴ is chlorine;
R⁵ is hydrogen;
R⁶, R⁷ independently of one another are C₁-C₆-alkyl.

Examples of particularly preferred herbicides Ia or Ib are the 3-phenyluracils of the formula I′ listed below wherein R¹, R⁶ and R⁷ have the meanings given in one row of table 1 (compounds 1.1 to 1.74).

TABLE 1

| | |
|---|---|
| | I′ |
| 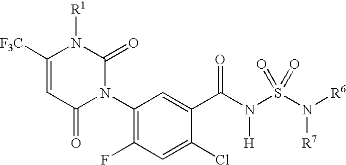 | |

| 3-phenyluracil I | R¹ | R⁶ | R⁷ |
|---|---|---|---|
| I.1 | methyl | methyl | methyl |
| I.2 | amino | methyl | methyl |
| I.3 | methyl | methyl | ethyl |
| I.4 | amino | methyl | ethyl |
| I.5 | methyl | methyl | propyl |
| I.6 | amino | methyl | propyl |
| I.7 | methyl | methyl | isopropyl |
| I.8 | amino | methyl | isopropyl |
| I.9 | methyl | methyl | butyl |
| I.10 | amino | methyl | butyl |
| I.11 | methyl | methyl | s-butyl |
| I.12 | amino | methyl | s-butyl |
| I.13 | methyl | methyl | isobutyl |
| I.14 | amino | methyl | isobutyl |
| I.15 | methyl | methyl | t-butyl |
| I.16 | amino | methyl | t-butyl |
| I.17 | methyl | methyl | n-pentyl |
| I.18 | amino | methyl | n-pentyl |
| I.19 | methyl | methyl | n-hexyl |
| I.20 | amino | methyl | n-hexyl |
| I.21 | methyl | methyl | allyl |
| I.22 | amino | methyl | allyl |
| I.23 | methyl | methyl | propargyl |
| I.24 | amino | methyl | propargyl |
| I.25 | methyl | methyl | phenyl |
| I.26 | amino | methyl | phenyl |
| I.27 | methyl | methyl | benzyl |
| I.28 | amino | methyl | benzyl |
| I.29 | methyl | ethyl | ethyl |
| I.30 | amino | ethyl | ethyl |
| I.31 | methyl | ethyl | propyl |
| I.32 | amino | ethyl | propyl |
| I.33 | methyl | ethyl | isopropyl |
| I.34 | amino | ethyl | isopropyl |
| I.35 | methyl | ethyl | butyl |
| I.36 | amino | ethyl | butyl |
| I.37 | methyl | ethyl | n-pentyl |
| I.38 | amino | ethyl | n-pentyl |
| I.39 | methyl | ethyl | n-hexyl |
| I.40 | amino | ethyl | n-hexyl |
| I.41 | methyl | propyl | propyl |
| I.42 | amino | propyl | propyl |
| I.43 | methyl | propyl | isopropyl |
| I.44 | amino | propyl | isopropyl |
| I.45 | methyl | propyl | butyl |
| I.46 | amino | propyl | butyl |
| I.47 | methyl | propyl | n-pentyl |
| I.48 | amino | propyl | n-pentyl |
| I.49 | methyl | propyl | n-hexyl |
| I.50 | amino | propyl | n-hexyl |
| I.51 | methyl | isopropyl | isopropyl |
| I.52 | amino | isopropyl | isopropyl |
| I.53 | methyl | isopropyl | butyl |
| I.54 | amino | isopropyl | butyl |
| I.55 | methyl | isopropyl | n-pentyl |
| I.56 | amino | isopropyl | n-pentyl |
| I.57 | methyl | isopropyl | n-hexyl |
| I.58 | amino | isopropyl | n-hexyl |
| I.59 | methyl | butyl | butyl |
| I.60 | amino | butyl | butyl |
| I.61 | methyl | butyl | n-pentyl |
| I.62 | amino | butyl | n-pentyl |
| I.63 | methyl | butyl | n-hexyl |
| I.64 | amino | butyl | n-hexyl |
| I.65 | methyl | n-pentyl | n-pentyl |
| I.66 | amino | n-pentyl | n-pentyl |
| I.67 | methyl | n-pentyl | n-hexyl |
| I.68 | amino | n-pentyl | n-hexyl |
| I.69 | methyl | n-hexyl | n-hexyl |
| I.70 | amino | n-hexyl | n-hexyl |

| | | |
|---|---|---|
| I.71 | methyl | —(CH₂)₄— |
| I.72 | amino | —(CH₂)₄— |
| I.73 | methyl | —(CH₂)₂—O—(CH₂)₂— |
| I.74 | amino | —(CH₂)₂—O—(CH₂)₂— |

Compounds I.1, I.3, I.5, I.7, I.9, I.11 and I.13 are particularly preferred.

Preferably, the 3-phenyluracils of formula I are used in combination with at least one (one or more) other herbicide (component B) or an agriculturally acceptable salt or derivative (provided the herbicide has a carboxyl group) thereof. The herbicides B are selected from the following classes b1) to b15):
b1) lipid biosynthesis inhibitors;
b2) acetolactate synthase inhibitors (ALS inhibitors);
b3) photosynthesis inhibitors;
b4) protoporphyrinogen-IX oxidase inhibitors;
b5) bleacher herbicides;
b6) enolpyruvyl shikimate 3-phosphate synthase inhibitors (EPSP inhibitors);
b7) glutamine synthetase inhibitors;
b8) 7,8-dihydropteroate synthase inhibitors (DHP inhibitors);
b9) mitose inhibitors;
b10) inhibitors of the synthesis of long chain fatty acids (VLCFA inhibitors);
b11) cellulose biosynthesis inhibitors;
b12) decoupler herbicides;
b13) auxin herbicides;
b14) auxin transport inhibitors;
b15) other herbicides selected from the group consisting of benzoylprop, flamprop, flamprop-M, bromobutide, chlorflurenol, cinmethylin, methyldymuron, etobenzanid, fosamine, metam, pyributicarb, oxaziclomefone, dazomet, triaziflam and methyl bromide;
   the agriculturally acceptable salts and the agriculturally acceptable derivatives thereof, provided they have a carboxyl group.

Preferred herbicides of groups b1) to b15) are the compounds listed below:
b1) from the group of the lipid biosynthesis inhibitors:
   chlorazifop, clodinafop, clofop, cyhalofop, diclofop, fenoxaprop, fenoxaprop-p, fenthiaprop, fluazifop, fluazifop-P, haloxyfop, haloxyfop-P, isoxapyrifop, metamifop, propaquizafop, quizalofop, quizalofop-P, trifop, alloxydim, butroxydim, clethodim, cloproxydim, cycloxydim, profoxydim, sethoxydim, tepraloxydim, tralkoxydim, butylate, cycloate, diallate, dimepiperate, EPTC, esprocarb, ethiolate, isopolinate, methiobencarb, molinate, orbencarb, pebulate, prosulfocarb, sulfallate, thiobencarb, tiocarbazil, triallate, vernolate, benfuresate, ethofumesate, bensulide and pinoxaden;
b2) from the group of the ALS inhibitors:
   amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, imazamethabenz, imazamox, imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid, pyrithiobac, flucetosulfuron, orthosulfamuron, pyrimisulfan, [N-(5,7-dimethoxy[1,2,4]triazolo[1,5-a]pyrimidin-2-yl-2-methoxy-4-(trifluormethyl)-3-pyridinesulfonamide, known from WO 02/36595;
b3) from the group of the photosynthesis inhibitors:
   atraton, atrazine, ametryne, aziprotryne, cyanazine, cyanatryn, chlorazine, cyprazine, desmetryne, dimethametryne, dipropetryn, eglinazine, ipazine, mesoprazine, methometon, methoprotryne, procyazine, proglinazine, prometon, prometryne, propazine, sebuthylazine, secbumeton, simazine, simeton, simetryne, terbumeton, terbuthylazine, terbutryne, trietazine, ametridione, amibuzin, hexazinone, isomethiozin, metamitron, metribuzin, bromacil, isocil, lenacil, terbacil, brompyrazon, chloridazon, dimidazon, desmedipham, phenisopham, phenmedipham, phenmedipham-ethyl, benzthiazuron, buthiuron, ethidimuron, isouron, methabenzthiazuron, monoisouron, tebuthiuron, thiazafluoron, anisuron, buturon, chlorbromuron, chloreturon, chlorotoluron, chloroxuron, difenoxuron, dimefuron, diuron, fenuron, fluometuron, fluothiuron, isoproturon, linuron, methiuron, metobenzuron, metobromuron, metoxuron, monolinuron, monuron, neburon, parafluoron, phenobenzuron, siduron, tetrafluoron, thidiazuron, cyperquat, diethamquat, difenzoquat, diquat, morfamquat, paraquat, bromobonil, bromoxynil, chloroxynil, iodobonil, ioxynil, amicarbazone, bromofenoxim, flumezin, methazole, bentazone, propanil, pentanochlor, pyridate, and pyridafol;
b4) from the group of the protoporphyrinogen-IX oxidase inhibitors: acifluorfen, bifenox, chlomethoxyfen, chlornitrofen, ethoxyfen, fluorodifen, fluoroglycofen, fluoronitrofen, fomesafen, furyloxyfen, halosafen, lactofen, nitrofen, nitrofluorfen, oxyfluorfen, fluazolate, pyraflufen, cinidon-ethyl, flumiclorac, flumioxazin, flumipropyn, fluthiacet, thidiazimin, oxadiazon, oxadiargyl, azafenidin, carfentrazone, sulfentrazone, pentoxazone, benzfendizone, butafenacil, pyraclonil, profluazol, flufenpyr, flupropacil, nipyraclofen, etnipromid, and bencarbazone;
b5) from the group of the bleacher herbicides: metflurazon, norflurazon, flufenican, diflufenican, picolinafen, beflubutamid, fluridone, fluorochloridone, flurtamone, mesotrione, sulcotrione, isoxachlortole, isoxaflutole, benzofenap, pyrazolynate, pyrazoxyfen, benzobicyclon, amitrole, clomazone, aclonifen, 4-(3-trifluoromethylphenoxy)-2-(4-trifluoromethylphenyl)pyrimidine, known from EP 723960, topramezone, 4-hydroxy-3-{[2-methyl-6-(trifluoromethyl)-3-pyridinyl]carbonyl}bicyclo[3.2.1]oct-3-en-2-one, known from WO 00/15615, 4-hydroxy-3-{[2-(2-methoxyethoxy)methyl-6-(trifluoro-methyl)-3-pyridinyl]carbonyl}bicylo[3.2.1]oct-3-en-2-one, known from WO 01/94339, 4-hydroxy-3-[4-(methylsulfonyl)-2-nitrobenzoyl]bicyclo[3.2.1]-oct-3-en-2-one, known from EP 338992, 2-[2-chloro-4-(methylsulfonyl)-3-[(2,2,2-trifluoroethoxy)methyl]benzoyl]-3-hydroxy-2-cyclohexen-1-one (known from DE 19846792), and pyrasulfotole;
b6) from the group of the EPSP synthase inhibitors: glyphosate;
b7) from the group of the glutamine synthase inhibitors: glufosinate and bilanaphos;
b8) from the group of the DHP synthase inhibitors: asulam;
b9) from the group of the mitose inhibitors:
   benfluralin, butralin, dinitramine, ethalfluralin, fluchloralin, isopropalin, methalpropalin, nitralin, oryzalin, pendimethalin, prodiamine, profluralin, trifluralin, amiprofos-methyl, butamifos, dithiopyr, thiazopyr, propyzamide, tebutam, chlorthal, carbetamide, chlorbufam, chlorpropham and propham;
b10) from the group of the VLCFA inhibitors: acetochlor, alachlor, butachlor, butenachlor, delachior, diethatyl, dimethachlor, dimethenamid, dimethenamid-P, metazachlor, metolachlor, S-metolachlor, pretilachlor, propachlor, propisochlor, prynachlor, terbuchlor, thenylchlor, xylachlor, allidochlor, CDEA, epronaz, diphenamid, napropamide, naproanilide, pethoxamid, flufenacet, mefenacet, fentrazamide, anilofos, piperophos, cafenstrole, indanofan and tridiphane;
b11) from the group of the cellulose biosynthesis inhibitors: dichlobenil, chlorthiamid, isoxaben and flupoxam;
b12) from the group of the decoupler herbicides: dinofenate, dinoprop, dinosam, dinoseb, dinoterb, DNOC, etinofen and medinoterb;
b13) from the group of the auxin herbicides:
   clomeprop, 2,4-D, 2,4,5-T, MCPA, MCPA thioethyl, dichlorprop, dichlorprop-P, mecoprop, mecoprop-P, 2,4-DB, MCPB, chloramben, dicamba, 2,3,6-TBA, tricamba, quinclorac, quinmerac, clopyralid, fluoroxypyr, picloram, triclopyr, benazolin and aminopyralid;
b14) from the group of the auxin transport inhibitors: naptalam, diflufenzopyr;
b15) benzoylprop, flamprop, flamprop-M, bromobutide, chlorflurenol, cinmethylin, methyldymron, etobenzanid, fosamine, metam, pyributicarb, oxaziclomefone, dazomet, triaziflam, methyl bromide;
   the agriculturally acceptable salts and the agriculturally acceptable derivatives of the herbicides, provided they have a carboxyl group.

According to a preferred embodiment the 3-phenyluracils I are used in combination with glyphosate or an agriculturally acceptable salt thereof.

According to a further preferred embodiment the 3-phenyluracils I are used in combination with glyphosate and at least one (one or more) further herbicide B, preferably selected from said groups b1) to b5) and b7) to b15) or an agriculturally acceptable salt or derivative thereof.

Further, the 3-phenyluracils of formula I, optionally in combination with said at least one herbicide B, may be used in combination with at least one (one or more) safener (component C) or an agriculturally acceptable salt thereof or an agriculturally acceptable derivate thereof provided it has a carboxyl group. The safener is preferably selected from the group consisting of benoxacor, cloquintocet, cyometrinil, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloroacetyl)-1,3-oxazolidine (R-29148), 4-(dichloroacetyl)-1-oxa-4-azaspiro[4.5]decane (AD-67, MON 4660) and oxabetrinil, including their agriculturally acceptable salts and, provided they have a carboxyl group, their agriculturally acceptable derivatives.

According to a further preferred embodiment the 3-phenyluracils I are used in combination with glyphosate or an agriculturally acceptable salt thereof, at least one further herbicide B, preferably selected from said groups b1) to b5) and b6) to b15), or an agriculturally acceptable salt or derivative thereof and at least one (one or more) safener C or an agriculturally acceptable salt or derivative thereof.

The herbicides B of groups b1) to b15) and the active compounds C are known herbicides and safeners, see the quoted literature references and, for example, The Compendium of Pesticide Common Names (http://www.hclrss.demon.co.uk/index.html); Farm Chemicals Handbook 2000 Vol. 86, Meister Publishing Company, 2000; B. Hock, C. Fedtke, R. R. Schmidt, Herbizide, Georg Thieme Verlag, Stuttgart 1995; W. H. Ahrens, Herbicide Handbook, 7^{th} Edition, Weed Science Society of America, 1994; and K. K. Hatzios, Herbicide Handbook, Supplement to 7^{th} Edition, Weed Science Society of America, 1998. 2,2,5-Trimethyl-3-(dichloroacetyl)-1,3-oxazolidine [CAS No. 52836-31-4] is also known under the name R-29148. 4-(Dichloroacetyl)-1-oxa-4-azaspiro[4.5]decane [CAS No. 71526-07-03] is also known under the names AD-67 and MON 4660.

The categorization of the active compounds according to their mode of action is based on current understanding. If an active compound acts by more than one mode of action, this substance was assigned to only one mode of action.

If the phenyluracils 1, the herbicides B and/or the safeners C are capable of forming geometrical isomers, for example E/Z isomers, it is possible to use both the pure isomers and mixtures thereof in the compositions according to the invention. If the phenyluracils I, the herbicides B and/or the safeners C have one or more centers of chirality and, as a consequence, are present as enantiomers or diastereomers, it is possible to use both the pure enantiomers and diastereomers and their mixtures in the compositions according to the invention.

If the phenyluracils 1, the herbicides B and/or the safeners C have functional groups which can be ionized, they can also be used in the form of their agriculturally acceptable salts. In general, the salts of those cations or the acid addition salts of those acids are suitable whose cations and anions, respectively, have no adverse effect on the action of the active compounds.

Preferred cations are the ions of the alkali metals, preferably of lithium, sodium and potassium, of the alkaline earth metals, preferably of calcium and magnesium, and of the transition metals, preferably of manganese, copper, zinc and iron, furthermore ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)eth-1-ylammonium, di(2-hydroxyeth-1-yl)ammonium, benzyltrimethylammonium, benzyltriethylammonium, furthermore phosphonium ions, sulfonium ions, preferably tri(C₁-C₄-alkyl)sulfonium such as trimethylsulfonium, and sulfoxonium ions, preferably tri(C₁-C₄-alkyl)sulfoxonium. It is possible to use the active compounds of the formula I and at least one herbicide B selected from chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, propaquizafop, quizalofop, quizalofop-P, trifop, alloxydim, butroxydim, clethodim, cloproxydim, cycloxydim, profoxydim, sethoxydim, tepraloxydim, tralkoxydim, amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, propoxycarbazon, flucarbazon, imazamethabenz, imazamox, imazapic, imazapyr, imazaquin, imazethapyr, cloransulam, diclosulam, florasulam, flumetsulam, metosulam, penoxsulam, bispyribac, pyrithiobac, flucetosulfuron, orthosulfamuron, pyrimisulfam, [N-(5,7-dimethoxy[1,2,4]triazolo[1,5-a]-pyrimidin-2-yl-2-methoxy-4-(trifluoromethyl)-3-pyridinsulfonamide, pyriminobac, bentazon, acifluorfen, ethoxyfen, fluoroglycofen, fomesafen, halosafen, lactofen, pyraflufen, flumiclorac, fluthiacet, carfentrazone, flufenpyr, mesotrione, sulcotrione, topramezone, 4-hydroxy-3-{[2-methyl-6-(trifluoromethyl)-3-pyridinyl]carbonyl}bicylo-[3.2.1 Joct-3-en-2-one, 4-hydroxy-3-{[2-(2-methoxyethoxy)methyl-6-(trifluoromethyl)-3-pyridinyl]carbonyl}bicyclo[3.2.1]oct-3-en-2-one, 4-hydroxy-3-[4-(methylsulfonyl)-2-nitrobenzoyl]-bicyclo[3.2.1]oct-3-en-2-one, 2-[2-chloro-4-(methylsulfonyl)-3-[(2,2,2-trifluoroethoxy)methyl]benzoyl]-3-hydroxy-2-cyclohexen-1-one, pyrasulfotole, glyphosate, glufosinate, bilanaphos, clomeprop, 2,4-D, 2,4-DB, dichlorprop, dichlorprop-P, MCPA, MCPB, mecoprop, mecoprop-P, 2,4,5-T, chloramben, dicamba, 2,3,6-TBA, tricamba, quinclorac, quinmerac, clopyralid, fluroxypyr, picloram, triclopyr, aminopyralid, naptalam, diflufenzopyr, cloquintocet, fenchlorazole, isoxadifen and mefenpyr, in the form of salts with the agriculturally useful cations mentioned above.

Anions of useful acid addition salts are primarily chloride, bromide, fluoride, iodide, hydrogen sulfate, methyl sulfate, sulfate, dihydrogen phosphate, hydrogen phosphate, nitrate, dicarbonate, carbonate, hexafluorosilicate, hexafluorophosphate, benzoate and the anions of C₁-C₄-alkanoic acids, preferably formate, acetate, propionate and butyrate.

According to the invention, the herbicides cyperquat, diethamquat, difenzoquat, diquat, morfamquat and paraquat are usually employed in the form of salts with the agriculturally useful anions mentioned above.

According to the invention, the active compounds which carry a carboxyl group can, instead of the active compounds mentioned above, also be employed in the form of an agriculturally acceptable derivative, for example as amides such as mono- or di-C₁-C₆-alkylamides or arylamides, as esters, for example as allyl esters, propargyl esters, C₁-C₁₀-alkyl esters or alkoxyalkyl esters, and also as thioesters, for example as C₁-C₁₀-alkyl thioesters. Examples of active compounds having a COOH group which can also be employed as derivatives are: chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, propaquizafop, quizalofop, quizalofop-P, trifop, bensulfuron, chlorimuron, ethametsulfuron, flupyrsulfuron, halosulfuron, iodosulfuron, mesosulfuron, metsulfuron, primisulfuron, pyrazosulfuron, sulfometuron, thifensulfuron, tribenuron, triflusulfuron, imazamethabenz, imazamox, imazapic, imazapyr, imazaquin, imazethapyr, cloransulam, bispyribac, pyrithiobac, pyriminobac, acifluorfen, ethoxyfen, fluoroglycofen, lactofen, pyraflufen, flumiclorac, fluthiacet, carfentrazone, flufenpyr, clomeprop, 2,4-D, 2,4-DB, dichlorprop, dichlorprop-P, MCPA, MCPB, mecoprop, mecoprop-P, 2,4,5-T, chloramben, dicamba, 2,3,6-TBA, tricamba, quinclorac, quinmerac, clopyralid, fluroxypyr, picloram, triclopyr, aminopyralid, naptalam, diflufenzopyr, cloquintocet, fenchlorazole, isoxadifen and mefenpyr.

Preferred mono- and di-C₁-C₆-alkylamides are the methyl- and the dimethylamides. Preferred arylamides are, for example, the anilidines and the 2-chloroanilides. Pre-ferred alkyl esters are, for example, the methyl, ethyl, propyl, isopropyl, butyl, isobutyl, pentyl, mexyl (1-methylhexyl) or isooctyl (2-ethylhexyl) esters. Preferred C₁-C₄-alkoxy-C₁-C₄-alkyl esters are the straight-chain or branched C₁-C₄-alkoxyethyl esters, for example the methoxyethyl, ethoxyethyl or butoxyethyl esters. An example of the straight-chain or branched C₁-C₁₀-alkyl thioesters is the ethyl thioester.

According to the invention binary and ternary compositions are used if at least one 3-phenyluracil of formula I as active compound A is used in combination with at least one herbicide B and/or in combination with at least one safener C. Here and below, the term “binary compositions” includes compositions which comprise one or more, for example 2 or 3, active compounds A and one or more, for example 2 or 3, herbicides B or one or more, for example 2 or 3, safeners C. Correspondingly, the term “ternary compositions” includes compositions which comprise one or more, for example 2 or 3, active compounds A, one or more, for example 2 or 3, herbicides B and one or more, for example 2 or 3, safeners C.

In binary compositions which comprise at least one 3-phenyluracil of the formula I as component A and at least one herbicide B, the weight ratio of the active compounds A:B is usually in the range from 1:500 to 10:1, preferably in the range from 1:100 to 10:1, in particular in the range from 1:50 to 10:1 and particularly preferably in the range from 1:25 to 5:1.

In binary compositions which comprise at least one 3-phenyluracil of the formula I and at least one safener C, the weight ratio of the active compounds A:C is usually in the range from 1:100 to 10:1, preferably from 1:50 to 10:1 and in particular in the range from 1:25 to 5:1.

In ternary compositions which comprise both a 3-phenyluracil I as component A, at least one herbicide B and at least one safener C, the relative weight ratios of the components A:B:C are usually in the range from 10:1:1 to 1:500:10, preferably from 10:1:1 to 1:100:10, in particular from 10:1:1 to 1:50:1 and particularly preferably from 5:1:1 to 1:25:5. In these ternary compositions, the weight ratio of herbicide B to safener C is preferably in the range from 50:1 to 1:10.

In a particularly preferred embodiment of the invention, preference is given to those compositions of the invention which comprise a 3-phenyluracil of the formula I, especially of formulae Ia or Ib, in combination with at least one and especially exactly one herbicidally active compound of the group b1), in particular selected from the group consisting of clodinafop, diclofop, fenoxaprop, fenoxaprop-P, profoxydim, sethoxydim, tepraloxydim, pinoxaden and tralkoxydim and, if desired, a safener C), in particular selected from the group consisting of fenclorazole, cloquintocet, isoxadifen and mefenpyr.

In another particularly preferred embodiment of the invention, preference is given to those compositions of the invention which comprise a 3-phenyluracil of the formula I, especially of formulae Ia or Ib, in combination with at least one and especially exactly one herbicidally active compound of the group b2), in particular selected from the group consisting of amidosulfuron, chlorsulfuron, foramsulfuron, iodosulfuron, mesosulfuron, metsulfuron, nicosulfuron, primisulfuron, prosulfuron, rimsulfuron, sulfosulfuron, tritosulfuron, propoxycarbazone, flucarbazone, imazamethabenz, imazamox, imazapic, imazapyr, imazaquin, imazethapyr, metosulam, diclosulam, florasulam, penoxsulam, pyriftalid, [N-(5,7-dimethoxy[1,2,4]triazolo[1,5-a]pyrimidin-2-yl-2-methoxy-4-(trifluormethyl)-3-pyridinesulfonamide and pyriminobac and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 3-phenyluracil of the formula I, especially of formulae Ia or Ib, in combination with at least one and especially exactly one herbicidally active compound of the group b3), in particular selected from the group consisting of atrazine, cyanazine, terbuthylazine, amicarbazone, chlorotoluron, diuron, isoproturon, methabenzthiazuron, propanil, bromoxynil, ioxynil and paraquat and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 3-phenyluracil of the formula I, especially of formulae Ia or Ib, in combination with at least one and especially exactly one herbicidally active compound of the group b5), in particular selected from the group consisting of diflufenican, picolinafen, mesotrione, sulcotrione, isoxaflutole, 4-(3-trifluoromethylphenoxy)-2-(4-trifluoromethylphenyl)pyrimidine, topramezone, 4-hydroxy-3-{[2-methyl-6-(trifluoromethyl)-3-pyridinyl]carbonyl}bicyclo[3.2.1]oct-3-en-2-one, 4-hydroxy-3-{[2-(2-methoxyethoxy)methyl-6-(trifluoro-methyl)-3-pyridinyl]carbonyl}bicylo[3.2.1]oct-3-en-2-one, 4-hydroxy-3-[4-(methylsulfonyl)-2-nitrobenzoyl]bicyclo[3.2.1]-oct-3-en-2-one, 2-[2-chloro-4-(methylsulfonyl)-3-[(2,2,2-trifluoroethoxy)methyl]benzoyl]-3-hydroxy-2-cyclohexen-1-one and pyrasulfotole, and, if desired, a safener C), in particular selected from the group consisting of furilazole, fenclorazole, cloquintocet, ioxadifen and mefenpyr.

In another particularly preferred embodiment of the invention, preference is given to those compositions of the invention which comprise a 3-phenyluracil of the formula I, especially of formulae Ia or Ib, in combination with at least one and especially exactly one herbicidally active compound of the group b6), in particular glyphosate and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 3-phenyluracil of the formula I, especially of formulae Ia or Ib, in combination with at least one and especially exactly one herbicidally active compound of the group b7), in particular glufosinate and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 3-phenyluracil of the formula I, especially of formulae Ia or Ib, in combination with at least one and especially exactly one herbicidally active compound of the group b9), in particular pendimethalin and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 3-phenyluracil of the formula I, especially of formulae Ia or Ib, in combination with at least one and especially exactly one herbicidally active compound of the group b10), in particular selected from the group consisting of acetochlor, butachlor, dimethenamid, dimethenamid-P, metolachlor, S-metolachlor, pethoxamid, pretilachlor, flufenacet, mefenacet and fentrazamide and, if desired, a safener C), in particular selected from the group consisting of 2,2,5-trimethyl-3-(dichloroacetyl)-1,3-oxazolidine, dichlormid, furilazole, oxabetrinil, fluxofenim, benoxacor, fenclorim and 4-(dichloroacetyl)-1-oxa-4-azaspiro[4.5]decane.

In another particularly preferred embodiment of the invention, preference is given to those compositions of the invention which comprise a 3-phenyluracil of the formula I, especially of formulae Ia or Ib, in combination with at least one and especially exactly one herbicidally active compound of the group b13), in particular selected from the group consisting of 2,4-D, dichlorprop, dichlorprop-P, mecoprop, MCPA, mecoprop-P, dicamba, quinclorac and quinmerac and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 3-phenyluracil of the formula I, especially of formulae Ia or Ib, in combination with at least one and especially exactly one herbicidally active compound of the group b14), in particular diflufenzopyr and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 3-phenyluracil of the formula I, especially of formulae Ia or Ib, in combination with at least one and especially exactly one herbicidally active compound of the group b15), in particular selected from the group consisting of cinmethylin, oxaziclomefone, triaziflam, and, if desired, a safener C), in particular selected from the group consisting of furilazole, fenclorazole, cloquintocet, isoxadifen and mefenpyr.

In another particularly preferred embodiment of the invention, preference is given to those compositions of the invention which comprise a 3-phenyluracil of the formula I, especially of formulae Ia or Ib, in combination with at least one herbicide B selected from dimethenamid-P, acetochlor, atrazine, (S)-metolachlor, alachlor, flufenacet, mesotrione, isoxaflutole, pendimethalin, sulfentrazone, chlorimuron, trifluralin, imazethapyr, imazaquin, paraquat, metribuzin, and their agriculturally acceptable salts and derivatives, optionally in combination with at least one safener. More preferably, the herbicide is selected from the group consisting of dimethenamid-P, acetochlor and (S)metolachlor.

In another particularly preferred embodiment of the invention, preference is given to those compositions of the invention which comprise a 3-phenyluracil of the formula I, especially of formulae Ia or Ib, in combination with at least one and especially exactly one safener C), in particular selected from the group consisting of furilazole, fenclorazole, cloquintocet, isoxadifen and mefenpyr.

In another particularly preferred embodiment of the invention, preference is given to those compositions of the invention which comprise a 3-phenyluracil of the formula I, especially of formulae Ia or Ib, in combination with at least one and especially exactly one safener C), in particular selected from the group consisting of 2,2,5-trimethyl-3-(dichloroacetyl)-1,3-oxazolidine, dichlormid, furilazole, oxabetrinil, fluxofenim, benoxacor, fenclorim and 4-(dichloroacetyl)-1-oxa-4-azaspiro[4.5]decane.

Particular preference is especially given to those compositions of the invention which comprise a 3-phenyluracil of the formula I, especially of formulae Ia or Ib, in combination with at least one and especially exactly one herbicidally active compound selected from the group consisting of tralkoxydim, profoxydim, fenoxaprop, fenoxaprop-P, imazamox, imazethapyr, nicosulfuron, atrazine, diuron, isoproturon, paraquat, cinidon-ethyl, picolinafen, sulcotrione, glyphosate, glufosinate, pendimethalin, dimethenamid, dimethenamid-P, acetochlor, metolachlor, S-metolachlor, isoxaben, dichlorprop, dichlorprop-P, dicamba, 2,4-D, diflufenzopyr and/or a safener C) selected from the group consisting of mefenpyr and benoxacor.

According to a most preferred embodiment, a 3-phenyluracil of formula I is used in combination with glyphosate and optionally in combination with safener C selected from benoxacor, cloquintocet, cyometrinil, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloroacetyl)-1,3-oxazolidine (R-29148), 4-(dichloroacetyl)-1-oxa-4-azaspiro[4.5]decane (AD-67, MON 4660) and oxabetrinil, including their agriculturally acceptable salts and, provided they have a carboxyl group, their agriculturally acceptable derivatives.

According to a further most preferred embodiment, a 3-phenyluracil of formula I is used in combination with imazethapyr and optionally in combination with safener C selected from benoxacor, cloquintocet, cyometrinil, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloroacetyl)-1,3-oxazolidine (R-29148), 4-(dichloroacetyl)-1-oxa-4-azaspiro[4.5]decane (AD-67, MON 4660) and oxabetrinil, including their agriculturally acceptable salts and, provided they have a carboxyl group, their agriculturally acceptable derivatives.

According to a further most preferred embodiment, a 3-phenyluracil of formula I is used in combination with dimethenamid or dimethenamid P and optionally in combination with safener C selected from benoxacor, cloquintocet, cyometrinil, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloroacetyl)-1,3-oxazolidine (R-29148), 4-(dichloroacetyl)-1-oxa-4-azaspiro[4.5]decane (AD-67, MON 4660) and oxabetrinil, including their agriculturally acceptable salts and, provided they have a carboxyl group, their agriculturally acceptable derivatives.

According to a further most preferred embodiment, a 3-phenyluracil of formula I is used in combination with glyphosate and optionally at least one other herbicide B selected from imazethapyr, dimethenamid and dimethenamid P, and optionally at least one safener C, including their agriculturally acceptable salts and, provided they have a carboxyl group, their agriculturally acceptable derivatives.

Preferably, the safener C is selected from the group consisting of benoxacor, dichlormid, fenclorim, fluxofenim, furilazole, naphthalic anhydride, 2,2,5-trimethyl-3-(dichloroacetyl)-1,3-oxazolidine, 4-(dichloroacetyl)-1-oxa-4-azaspiro[4.5]decane and oxabetrinil.

Particular preference is given, for example, to those compositions which, as active compound A), comprise the phenyluracil I.7 and, as further active compound, the sub-stances listed in one row of Table 2 (compositions 1.1 to 1.353). The weight ratios of the individual components in the compositions 1.1 to 1.353 are within the stated limits, in the case of binary mixtures of phenyluracil I.7 and herbicide B) for example 1:1, 1:2 or 1:5, in the case of binary mixtures of phenyluracil I.7 and safener C for example 1:1, 1:2 or 1:5 and in the case of ternary mixtures of phenyluracil I.7, herbicide B and safener C for example 1:1:1, 2:1:1, 1:2:1, 1:5:1 or 1:5:2.

TABLE 2

| Compo- | | |
|---|---|---|
| sition | | |
| No. | Herbicide B) | Safener C) |
| 1.1 | clodinafop | |
| 1.2 | clodinafop | cloquintocet |
| 1.3 | clodinafop | fenchlorazole |
| 1.4 | clodinafop | isoxadifen |
| 1.5 | clodinafop | mefenpyr |
| 1.6 | cyhalofop | |
| 1.7 | cyhalofop | cloquintocet |
| 1.8 | cyhalofop | fenchlorazole |
| 1.9 | cyhalofop | isoxadifen |
| 1.10 | cyhalofop | mefenpyr |
| 1.11 | diclofop | |
| 1.12 | diclofop | cloquintocet |
| 1.13 | diclofop | fenchlorazole |
| 1.14 | diclofop | isoxadifen |
| 1.15 | diclofop | mefenpyr |
| 1.16 | fenoxaprop | |
| 1.17 | fenoxaprop | cloquintocet |
| 1.18 | fenoxaprop | fenchlorazole |
| 1.19 | fenoxaprop | isoxadifen |
| 1.20 | fenoxaprop | mefenpyr |
| 1.21 | fenoxaprop-P | — |
| 1.22 | fenoxaprop-P | cloquintocet |
| 1.23 | fenoxaprop-P | fenchlorazole |
| 1.24 | fenoxaprop-P | isoxadifen |
| 1.25 | fenoxaprop-P | mefenpyr |
| 1.26 | fluazifop | — |
| 1.27 | fluazifop | cloquintocet |
| 1.28 | fluazifop | fenchlorazole |
| 1.29 | fluazifop | isoxadifen |
| 1.30 | fluazifop | mefenpyr |
| 1.31 | fluazifop-P | — |
| 1.32 | fluazifop-P | cloquintocet |
| 1.33 | fluazifop-P | fenchlorazole |
| 1.34 | fluazifop-P | isoxadifen |
| 1.35 | fluazifop-P | mefenpyr |
| 1.36 | haloxyfop | — |
| 1.37 | haloxyfop | cloquintocet |
| 1.38 | haloxyfop | fenchlorazole |
| 1.39 | haloxyfop | isoxadifen |
| 1.40 | haloxyfop | mefenpyr |
| 1.41 | haloxyfop-P | — |
| 1.42 | haloxyfop-P | cloquintocet |
| 1.43 | haloxyfop-P | fenchlorazole |
| 1.44 | haloxyfop-P | isoxadifen |
| 1.45 | haloxyfop-P | mefenpyr |
| 1.46 | quizalofop | — |
| 1.47 | quizalofop | cloquintocet |
| 1.48 | quizalofop | fenchlorazole |
| 1.49 | quizalofop | isoxadifen |
| 1.50 | quizalofop | mefenpyr |
| 1.51 | quizalofop-P | — |
| 1.52 | quizalofop-P | cloquintocet |
| 1.53 | quizalofop-P | fenchlorazole |
| 1.54 | quizalofop-P | isoxadifen |
| 1.55 | quizalofop-P | mefenpyr |
| 1.56 | alloxydim | — |
| 1.57 | butroxydim | — |
| 1.58 | clethodim | — |
| 1.59 | cloproxydim | — |
| 1.60 | cycloxydim | — |
| 1.61 | profoxydim | — |
| 1.62 | sethoxydim | — |
| 1.63 | tepraloxydim | — |
| 1.64 | tralkoxydim | — |
| 1.65 | amidosulfuron | — |
| 1.66 | amidosulfuron | cloquintocet |
| 1.67 | amidosulfuron | fenchlorazole |
| 1.68 | amidosulfuron | isoxadifen |
| 1.69 | amidosulfuron | mefenpyr |
| 1.70 | amidosulfuron | furilazole |
| 1.71 | azimsulfuron | — |
| 1.72 | bensulfuron | — |
| 1.73 | chlorimuron | — |
| 1.74 | chlorsulfuron | — |
| 1.75 | cinosulfuron | — |
| 1.76 | cyclosulfamuron | — |
| 1.77 | ethametsulfuron | — |
| 1.78 | ethoxysulfuron | — |
| 1.79 | flazasulfuron | — |
| 1.80 | flupyrsulfuron | — |
| 1.81 | foramsulfuron | — |
| 1.82 | foramsulfuron | cloquintocet |
| 1.83 | foramsulfuron | fenchlorazole |
| 1.84 | foramsulfuron | isoxadifen |
| 1.85 | foramsulfuron | mefenpyr |
| 1.86 | foramsulfuron | furilazole |
| 1.87 | halosulfuron | — |
| 1.88 | halosulfuron | cloquintocet |
| 1.89 | halosulfuron | fenchlorazole |
| 1.90 | halosulfuron | isoxadifen |
| 1.91 | halosulfuron | mefenpyr |
| 1.92 | halosulfuron | furilazole |
| 1.93 | imazosulfuron | — |
| 1.94 | iodosulfuron | — |
| 1.95 | iodosulfuron | cloquintocet |
| 1.96 | iodosulfuron | fenchlorazole |
| 1.97 | iodosulfuron | isoxadifen |
| 1.98 | iodosulfuron | mefenpyr |
| 1.99 | iodosulfuron | furilazole |
| 1.100 | mesosulfuron | — |
| 1.101 | mesosulfuron | cloquintocet |
| 1.102 | mesosulfuron | fenchlorazole |
| 1.103 | mesosulfuron | isoxadifen |
| 1.104 | mesosulfuron | mefenpyr |
| 1.105 | mesosulfuron | furilazole |
| 1.106 | metsulfuron | — |
| 1.107 | nicosulfuron | — |
| 1.108 | oxasulfuron | — |
| 1.109 | primisulfuron | — |
| 1.110 | prosulfuron | — |
| 1.111 | pyrazosulfuron | — |
| 1.112 | rimsulfuron | — |
| 1.113 | sulfometuron | — |
| 1.114 | sulfosulfuron | — |
| 1.115 | thifensulfuron | — |
| 1.116 | triasulfuron | — |
| 1.117 | tribenuron | — |
| 1.118 | trifloxysulfuron | — |
| 1.119 | triflusulfuron | — |
| 1.120 | tritosulfuron | — |
| 1.121 | propoxycarbazone | — |
| 1.122 | flucarbazone | — |
| 1.123 | imazamethabenz | — |
| 1.124 | imazamox | — |
| 1.125 | imazapic | — |
| 1.126 | imazapyr | — |
| 1.127 | imazaquin | — |
| 1.128 | imazethapyr | — |
| 1.129 | cloransulam | — |
| 1.130 | diclosulam | — |
| 1.131 | florasulam | — |
| 1.132 | flumetsulam | — |
| 1.133 | metosulam | — |
| 1.134 | penoxsulam | — |
| 1.135 | bispyribac | — |
| 1.136 | pyribenzoxim | — |
| 1.137 | pyriftalid | — |
| 1.138 | pyrithiobac | — |
| 1.139 | pyriminobac | — |
| 1.140 | atrazine | — |
| 1.141 | cyanazine | — |
| 1.142 | simazine | — |
| 1.143 | terbuthylazine | — |
| 1.144 | hexazinone | — |
| 1.145 | metamitron | — |
| 1.146 | metribuzin | — |
| 1.147 | amicarbazone | — |
| 1.148 | chloridazon | — |
| 1.149 | chlorbromuron | — |
| 1.150 | chlorotoluron | — |
| 1.151 | diuron | — |
| 1.152 | isoproturon | — |
| 1.153 | linuron | — |
| 1.154 | methabenzthiazuron | — |
| 1.155 | propanil | — |
| 1.156 | bromoxynil | — |
| 1.157 | ioxynil | — |
| 1.158 | bentazone | — |
| 1.159 | pyridate | — |
| 1.160 | difenzoquat | — |
| 1.161 | diquat | — |
| 1.162 | paraquat | — |
| 1.163 | acifluorfen | — |
| 1.164 | fluoroglycofen | — |
| 1.165 | halosafen | — |
| 1.166 | lactofen | — |
| 1.167 | oxyfluorfen | — |
| 1.168 | fluazolate | — |
| 1.169 | pyraflufen | — |
| 1.170 | cinidon-ethyl | — |
| 1.171 | flumiclorac | — |
| 1.172 | flumioxazin | — |
| 1.173 | fluthiacet | — |
| 1.174 | oxadiazon | — |
| 1.175 | oxadiargyl | — |
| 1.176 | azafenidin | — |
| 1.177 | carfentrazone | — |
| 1.178 | sulfentrazone | — |
| 1.179 | pentoxazone | — |
| 1.180 | benzfendizone | — |
| 1.181 | butafenacil | — |
| 1.182 | pyraclonil | — |
| 1.183 | profluazol | — |
| 1.184 | flufenpyr | — |
| 1.185 | nipyraclofen | — |
| 1.186 | norflurazon | — |
| 1.187 | diflufenican | — |
| 1.188 | picolinafen | — |
| 1.189 | beflubutamid | — |
| 1.190 | fluridone | — |
| 1.191 | flurochloridone | — |
| 1.192 | flurtamone | — |
| 1.193 | mesotrione | — |
| 1.194 | sulcotrione | — |
| 1.195 | isoxachlortole | — |
| 1.196 | isoxaflutole | — |
| 1.197 | benzofenap | — |
| 1.198 | pyrazolynate | — |
| 1.199 | pyrazoxyfen | — |
| 1.200 | benzobicyclon | — |
| 1.201 | clomazone | — |
| 1.202 | pinoxaden | — |
| 1.203 | flucetosulfuron | — |
| 1.204 | orthosulfanuron | — |
| 1.205 | pyrimisulfan | — |
| 1.206 | glyphosate | — |
| 1.207 | glufosinate | — |
| 1.208 | benfluralin | — |
| 1.209 | butralin | — |
| 1.210 | dinitramine | — |
| 1.211 | ethalfluralin | — |
| 1.212 | oryzalin | — |
| 1.213 | pendimethalin | — |
| 1.214 | trifluralin | — |
| 1.215 | propyzamide | — |
| 1.216 | acetochlor | — |
| 1.217 | acetochlor | dichlormid |
| 1.218 | acetochlor | furilazole |
| 1.219 | acetochlor | oxabetrinil |
| 1.220 | acetochlor | fluxofenim |
| 1.221 | acetochlor | benoxacor |
| 1.222 | acetochlor | fenclorim |
| 1.223 | alachlor | — |
| 1.224 | butachlor | — |
| 1.225 | butachlor | dichlormid |
| 1.226 | butachlor | furilazole |
| 1.227 | butachlor | oxabetrinil |
| 1.228 | butachlor | fluxofenim |
| 1.229 | butachlor | benoxacor |
| 1.230 | butachlor | fenclorim |
| 1.231 | dimethenamid | — |
| 1.232 | dimethenamid | dichlormid |
| 1.233 | dimethenamid | furilazole |
| 1.234 | dimethenamid | oxabetrinil |
| 1.235 | dimethenamid | fluxofenim |
| 1.236 | dimethenamid | benoxacor |
| 1.237 | dimethenamid | fenclorim |
| 1.238 | dimethenamid-P | — |
| 1.239 | dimethenamid-P | dichlormid |
| 1.240 | dimethenamid-P | furilazole |
| 1.241 | dimethenamid-P | oxabetrinil |
| 1.242 | dimethenamid-P | fluxofenim |
| 1.243 | dimethenamid-P | benoxacor |
| 1.244 | dimethenamid-P | fenclorim |
| 1.245 | metazachlor | — |
| 1.246 | metolachlor | — |
| 1.247 | metolachlor | dichlormid |
| 1.248 | metolachlor | furilazole |
| 1.249 | metolachlor | oxabetrinil |
| 1.250 | metolachlor | fluxofenim |
| 1.251 | metolachlor | benoxacor |
| 1.252 | metolachlor | fenclorim |
| 1.253 | S-metolachlor | — |
| 1.254 | S-metolachlor | dichlormid |
| 1.255 | S-metolachlor | furilazole |
| 1.256 | S-metolachlor | oxabetrinil |
| 1.257 | S-metolachlor | fluxofenim |
| 1.258 | S-metolachlor | benoxacor |
| 1.259 | S-metolachlor | fenclorim |
| 1.260 | pethoxamid | — |
| 1.261 | pretilachlor | — |
| 1.262 | pretilachlor | dichlormid |
| 1.263 | pretilachlor | furilazole |
| 1.264 | pretilachlor | oxabetrinil |
| 1.265 | pretilachlor | fluxofenim |
| 1.266 | pretilachlor | benoxacor |
| 1.267 | pretilachlor | fenclorim |
| 1.268 | flupoxam | — |
| 1.269 | propachlor | — |
| 1.270 | propisochlor | — |
| 1.271 | thenylchlor | — |
| 1.272 | flufenacet | — |
| 1.273 | mefenacet | — |
| 1.274 | fentrazamide | — |
| 1.275 | cafenstrole | — |
| 1.276 | indanofan | — |
| 1.277 | dichlobenil | — |
| 1.278 | chlorthiamid | — |
| 1.279 | isoxaben | — |
| 1.280 | 2,4-D | — |
| 1.281 | 2,4-DB | — |
| 1.282 | dichlorprop | — |
| 1.283 | dichlorprop-P | — |
| 1.284 | MCPA | — |
| 1.285 | MCPB | — |
| 1.286 | mecoprop | — |
| 1.287 | mecoprop-P | — |
| 1.288 | dicamba | — |
| 1.289 | quinclorac | — |
| 1.290 | quinmerac | — |
| 1.291 | clopyralid | — |
| 1.292 | fluroxypyr | — |
| 1.293 | picloram | — |
| 1.294 | triclopyr | — |
| 1.295 | benazolin | — |
| 1.296 | diflufenzopyr | — |
| 1.297 | bromobutide | — |
| 1.298 | cinmethylin | — |
| 1.299 | methyldymron | — |
| 1.300 | oxaziclomefone | — |
| 1.301 | triaziflam | — |
| 1.302 | — | benoxacor |
| 1.303 | — | cloquintocet |
| 1.304 | — | cyometrinil |
| 1.305 | — | dichlormid |
| 1.306 | — | dicyclonon |
| 1.307 | — | dietholate |
| 1.308 | — | fenchlorazole |
| 1.309 | — | fenclorim |
| 1.310 | — | flurazole |
| 1.311 | — | fluxofenim |
| 1.312 | — | furilazole |
| 1.313 | — | isoxadifen |
| 1.314 | — | mefenpyr |
| 1.315 | — | mephenate |
| 1.316 | — | naphthalic |
| | | anhydride |
| 1.317 | — | oxabetrinil |
| 1.318 | — | 2,2,5-trimethyl-3- |
| | | (dichloroacetyl) |
| | | oxazolidine |
| 1.319 | 4-(3-trifluoromethylphenoxy)-2-(4- | — |
| | trifluoromethylphenyl)pyrimidine | |
| 1.320 | acetochlor | 2,2,5-trimethyl-3- |
| | | (dichloro- |
| | | acetyl)-1,3-oxa- |
| | | zolidine |
| 1.321 | butachlor | 2,2,5-trimethyl-3- |
| | | (dichloro-acetyl)-1,3- |
| | | oxa-zolidine |
| 1.322 | dimethenamid | 2,2,5-trimethyl-3- |
| | | (dichloro- |
| | | acetyl)-1,3-oxa- |
| | | zolidine |
| 1.323 | dimethenamid-P | 2,2,5-trimethyl-3- |
| | | (dichloro- |
| | | acetyl)-1,3-oxa- |
| | | zolidine |
| 1.324 | metolachlor | 2,2,5-trimethyl-3- |
| | | (dichloro- |
| | | acetyl)-1,3-oxa- |
| | | zolidine |
| 1.325 | S-metolachlor | 2,2,5-trimethyl-3- |
| | | (dichloro- |
| | | acetyl)-1,3-oxa- |
| | | zolidine |
| 1.326 | pretilachlor | 2,2,5-trimethyl-3- |
| | | (dichloro- |
| | | acetyl)-1,3-oxa- |
| | | zolidine |
| 1.327 | pethoxamid | 2,2,5-trimethyl-3- |
| | | (dichloro- |
| | | acetyl)-1,3-oxa- |
| | | zolidine |
| 1.328 | pethoxamid | dichlormid |
| 1.329 | pethoxamid | furilazole |
| 1.330 | pethoxamid | oxabetrinil |
| 1.331 | pethoxamid | fluxofenim |
| 1.332 | pethoxamid | benoxacor |
| 1.333 | pethoxamid | fenclorim |
| 1.334 | pethoxamid | 4-(dichloro- |
| | | acetyl)-1-oxa-4- |
| | | azaspiro[4.5]-decane |
| 1.335 | acetochlor | 4-(dichloro- |
| | | acetyl)-1-oxa-4-aza- |
| | | spiro[4.5]-decane |
| 1.336 | butachlor | 4-(dichloro- |
| | | acetyl)-1-oxa-4-aza- |
| | | spiro[4.5]-decane |
| 1.337 | dimethenamid | 4-(dichloro- |
| | | acetyl)-1-oxa-4-aza- |
| | | spiro[4.5]-decane |
| 1.338 | dimethenamid-P | 4-(dichloro- |
| | | acetyl)-1-oxa-4-aza- |
| | | spiro[4.5]-decane |
| 1.339 | metolachlor | 4-(dichloro- |
| | | acetyl)-1-oxa-4-aza- |
| | | spiro[4.5]-decane |
| 1.340 | S-metolachlor | 4-(dichloro- |
| | | acetyl)-1-oxa-4-aza- |
| | | spiro[4.5]-decane |
| 1.341 | pretilachlor | 4-(dichloro- |
| | | acetyl)-1-oxa-4-aza- |
| | | spiro[4.5]-decane |
| 1.342 | metamifop | — |
| 1.343 | metamifop | cloquintocet |
| 1.344 | metamifop | fenchlorazole |
| 1.345 | metamifop | isoxadifen |
| 1.346 | metamifop | mefenpyr |
| 1.347 | topramezone | — |
| 1.348 | bencarbozone | — |
| 1.349 | 4-hydroxy-3-{[2-methyl- | — |
| | 6-(trifluoromethyl)-3- | |
| | pyridinyl]carbonyl}bicyclo[3.2.1]oct- | |
| | 3-en-2-one | |
| 1.350 | 4-hydroxy-3-{[2-(2- | — |
| | methoxyethoxy)methyl-6- | |
| | (trifluoromethyl)-3- | |
| | pyridinyl]carbonyl}bicylo[3.2.1]oct- | |
| | 3-en-2-one | |
| 1.351 | 4-hydroxy-3-[4-(methylsulfonyl)-2- | — |
| | nitrobenzoyl]bicyclo[3.2.1]- | |
| | oct-3-en-2-one | |
| 1.352 | 2-[2-chloro-4-(methylsulfonyl)- | — |
| | 3-[(2,2,2- | |
| | trifluoroethoxy)methyl]benzoyl]- | |
| | 3-hydroxy-2-cyclohexen-1-one | |
| 1.353 | pyrasulfotole | — |

If the active compounds mentioned in table 2 have functional groups which can be ionized, they can also be present in the form of their agriculturally acceptable salts as illustrated above. If the active compounds mentioned in table 2 have a carboxyl group they can also be present in the form of agriculturally acceptable derivatives as discussed above.

Preference is also given to the compositions 2.1-2.353 which differ from the corresponding compositions 1.1-1.353 only in that the phenyluracil I.7 is replaced by the phenyluracil I.1.

Preference is also given to the compositions 3.1-3.353 which differ from the corresponding compositions 1.1-1.353 only in that the phenyluracil I.7 is replaced by the phenyluracil I.2.

Preference is also given to the compositions 4.1-4.353 which differ from the corresponding compositions 1.1-1.353 only in that the phenyluracil I.7 is replaced by the phenyluracil I.3.

Preference is also given to the compositions 5.1-5.353 which differ from the corresponding compositions 1.1-1.353 only in that the phenyluracil I.7 is replaced by the phenyluracil I.4.

Preference is also given to the compositions 6.1-6.353 which differ from the corresponding compositions 1.1-1.353 only in that the phenyluracil I.7 is replaced by the phenyluracil I.5.

Preference is also given to the compositions 7.1-7.353 which differ from the corresponding compositions 1.1-1.353 only in that the phenyluracil I.7 is replaced by the phenyluracil I.6.

Preference is also given to the compositions 8.1-8.353 which differ from the corresponding compositions 1.1-1.353 only in that the phenyluracil I.7 is replaced by the phenyluracil I.8.

Preference is also given to the compositions 9.1-9.353 which differ from the corresponding compositions 1.1-1.353 only in that the phenyluracil I.7 is replaced by the phenyluracil I.9.

Preference is also given to the compositions 10.1-10.353 which differ from the corresponding compositions 1.1-1.353 only in that the phenyluracil I.7 is replaced by the phenyluracil I.10.

Preference is also given to the compositions 11.1-11.353 which differ from the corresponding compositions 1.1-1.353 only in that the phenyluracil I.7 is replaced by the phenyluracil I.11.

Preference is also given to the compositions 12.1-12.353 which differ from the corresponding compositions 1.1-1.353 only in that the phenyluracil I.7 is replaced by the phenyluracil I.12.

Preference is also given to the compositions 13.1-13.353 which differ from the corresponding compositions 1.1-1.353 only in that the phenyluracil I.7 is replaced by phenyluracil I.13.

Preference is also given to the compositions 14.1-74.353 which differ from the corresponding compositions 1.1-1.353 only in that the phenyluracil I.7 is replaced by one of the phenyluracils I.14. to I.74

The weight ratios of the individual components in the compositions 2.1 to 74.353 are within the limits stated above, in the case of binary mixtures of phenyluracil I.1 and herbicide B) for example 1:1, 1:2 or 1:5, in the case of binary mixtures of phenyluracil 1.1 and safener C for example 1:1, 1:2 or 1:5 and in the case of ternary mixtures of phenyluracil I.1, herbicide B and safener C for example 1:1:1, 2:1:1, 1:2:1, 1:5:1 or 1:5:2.

For application ready-to-use preparations in the form of crop protection products can be employed. Component A, optionally component B and/or optionally component C may be present in suspended, emulsified or dissolved form and can be formulated jointly or seperately. The application forms depend entirely on the intended use.

The preparations can be applied, for example, in the form of directly sprayable aqueous solutions, powders, suspensions, also highly-concentrated aqueous, oily or other suspensions or dispersions, emulsions, oil dispersions, pastes, dusts, materials for spreading or granules, by means of spraying, atomizing, dusting, broadcasting or watering. The use forms depend on the intended use; in any case, they should ensure the finest possible distribution of the active compounds.

Depending on the form in which the ready-to-use preparations are present, they comprise one or more liquid or solid carriers, if appropriate surfactants and if appropriate further auxiliaries which are customary for formulating crop protection products. The person skilled in the art is sufficiently familiar with the recipes for such formulations.

The ready-to-use preparations may comprise auxiliaries which are customary for mulating crop protection products, which auxiliaries may also comprise a liquid carrier.

Suitable inert additives with carrier function are essentially: mineral oil fractions of medium to high boiling point, such as kerosene and diesel oil, furthermore coal tar oils and oils of vegetable or animal origin, aliphatic, cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, e.g. amines such as N-methylpyrrolidone, and water.

Aqueous use forms can be prepared from emulsion concentrates, suspensions, pastes, wettable powders or water-dispersible granules by adding water. To prepare emulsions, pastes or oil dispersions, the active compound (s) as such or dissolved in an oil or solvent, can be homogenized in water by means of wetting agent, tackifier, dispersant or emulsifier. Alternatively, it is possible to prepare concentrates consisting of active substance, wetting agent, tackifier, dispersant or emulsifier and, if desired, solvent or oil, and these concentrates are suitable for dilution with water.

Suitable surfactants are the alkali metal salts, alkaline earth metal salts and ammonium salts of aromatic sulfonic acids, e.g. ligno-, phenol-, naphthalene- and dibutylnaphthalenesulfonic acid, and of fatty acids, of alkyl- and alkylarylsulfonates, of alkyl sulfates, lauryl ether sulfates and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl polyglycol ethers, tributylphenyl polyglycol ether, alkylaryl polyether alcohols, isotridecyl alcohol, fatty alcohol/ethylene oxide condensates, ethoxylated castor oil, polyoxyethylene alkyl ether or polyoxypropylene alkyl ether, lauryl alcohol polyglycol ether acetate, sorbitol esters, lignosulfite waste liquors or methylcellulose.

Powders, materials for spreading and dusts can be prepared by mixing or concomitant grinding of the active substances with a solid carrier.

Granules, e.g. coated granules, impregnated granules and homogeneous granules, can be prepared by binding the active ingredient (s) to solid carriers. Solid carriers are mineral earths such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate, ammonium nitrate, ureas, and products of vegetable origin such as cereal meal, tree bark meal, wood meal and nutshell meal, cellulose powders, or other solid carriers.

The concentrations of the active compound (s) in the ready-to-use preparations can be varied within wide ranges. In general, the formulations comprise from 0.001 to 98% by weight, preferably 0.01 to 95% by weight, of active ingredient (s). The active ingredient (s) are employed in a purity of from 90% to 100%, preferably 95% to 100% (according to NMR spectrum).

The preparations can, for example, be formulated as follows:
I 20 parts by weight of the active compound (s) in question are dissolved in a composition composed of 80 parts by weight of alkylated benzene, 10 parts by weight of the adduct of 8 to 10 mol of ethylene oxide to 1 mol of oleic acid N-monoethanolamide, parts by weight of calcium dodecylbenzenesulfonate and 5 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active ingredient.
II 20 parts by weight of the active compound (s) in question are dissolved in a composition composed of 40 parts by weight of cyclohexanone, 30 parts by weight of isobutanol, 20 parts by weight of the adduct of 7 mol of ethylene oxide to 1 mol of isooctylphenol and 10 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active ingredient.
III 20 parts by weight of the active compound (s) in question are dissolved in a composition composed of 25 parts by weight of cyclohexanone, 65 parts by weight of a mineral oil fraction of boiling point 210 to 280° C. and 10 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active ingredient.
IV 20 parts by weight of the active compound (s) in question are mixed thoroughly with 3 parts by weight of sodium diisobutylnaphthalenesulfonate, 17 parts by weight of the sodium salt of a lignosulfonic acid from a sulfite waste liquor and 60 parts by weight of pulverulent silica gel, and the composition is ground in a hammer mill. Finely distributing the composition in 20 000 parts by weight of water gives a spray composition which comprises 0.1% by weight of the active ingredient.
V 3 parts by weight of the active compound (s) in question are mixed with 97 parts by weight of finely divided kaolin. This gives a dust which comprises 3% by weight of the active ingredient.
VI 20 parts by weight of the active compound (s) in question are mixed intimately with 2 parts by weight of calcium dodecylbenzenesulfonate, 8 parts by weight of fatty alcohol polyglycol ether, 2 parts by weight of the sodium salt of a phenol-urea-formaldehyde condensate and 68 parts by weight of a paraffinic mineral oil. This gives a stable oily dispersion.
VII 1 part by weight of the active compound (s) in question is dissolved in a composition composed of 70 parts by weight of cyclohexanone, 20 parts by weight of ethoxylated isooctylphenol and 10 parts by weight of ethoxylated castor oil. This gives a stable emulsion concentrate.
VIII 1 part by weight of the active compound (s) in question is dissolved in a composition composed of 80 parts by weight of cyclohexanone and 20 parts by weight of Wettol EM 31 (nonionic emulsifier based on ethoxylated castor oil). This gives a stable emulsion concentrate.

The components A, B and C can be formulated jointly or separately.

The components A, B and C can be applied jointly or separately, simultaneously or successively, before, during or after emergence of the plants.

If the active compound (s) are less well tolerated by certain crop plants, it is possible to use application methods in which the herbicidal compositions are sprayed with the aid of sprayers in such a way that the leaves of the sensitive crop plants are as far as possible unaffected, whereas the active compounds reach the leaves of the undesirable plants growing underneath or the uncovered soil surface (post-directed, lay-by).

The required application rate of the pure active compounds, i.e. of A, optionally in combination with B and/or optionally in combination with C without formulation auxiliary, depends on the density of the undesired vegetation, on the development stage of the plants, on the climatic conditions of the location where the composition is used and on the application method. In general, the application rate is from 0.001 to 3 kg/ha, preferably from 0.005 to 2 kg/ha and in particular from 0.01 to 1 kg/ha, from 0.1 g/ha to 1 kg/ha, from 1 g/ha to 500 g/ha or from 5 g/ha to 500 g/ha of active substance.

The preparations are applied to the plants mainly by spraying, in particular foliar spraying. Application can be carried out by customary spraying techniques using, for example, water as carrier and spray liquid rates of from about 50 to 1 000 l/ha (for example from 300 to 400 l/ha). Application of the preparations by the low-volume and the ultra-low-volume method is possible, as is their application in the form of microgranules.

In a preferred embodiment of the invention, the phenyluracils of formula I or the composition of active ingredients are applied in a rate which provides long-term weed control when applied early pre-plant (i.e. up to 60 days prior to planting) up to pre-emergence (i.e. after planting but prior to crop emergence), or when applied post-directed.

In another preferred embodiment of the invention, weed control is provided by an application of the phenyluracils of formula I or the composition of active ingredients before the crop is seeded, planted or emerged (pre-emergence or pre-plant application), followed by one or more treatments after the crop is emerged with one or more herbicides which are selective in the crop.

Moreover, it may be useful to apply the compositions according to the invention jointly as a mixture with other crop protection products, for example with pesticides or agents for controlling phytopathogenic fungi or bacteria. Also of interest is the miscibility with mineral salt solutions which are employed for treating nutritional and trace element deficiencies. Non-phytotoxic oils and oil concentrates may also be added.

According to a preferred embodiment, the invention provides for weed control in soybean and corn crops.

In another preferred embodiment of the invention, the weed control is provided in transgenic or resistant soybean, cotton, canola, flax, lentil, rice, sugar beet, sunflower, tobacco, wheat, or corn crops. More preferably, the transgenic or resistant crop of soybean, cotton, canola, flax, lentil, rice, sugar beet, sunflower, tobacco, wheat, or corn is a glyphosate resistant crop, an oxynil resistant crop, a glufosinate resistant crop, an imidazolinone resistant crop, a sulfonylurea resistant crop, a dicamba tolerant crop, a cyclohexanedione resistant crop, a PPO resistant crop, an HPPD resistant crop, a fungus resistant crop, an insect resistant crop, or a crop which by means of multiple changes of the genome (“stacked traits”) exhibits more than one of said resistance properties. Most preferably, the crop of soybean, cotton, canola, flax, lentil, rice, sugar beet, sunflower, tobacco, wheat, or corn is a glyphosate resistant crop or a crop which by means of multiple changes of the genome (“stacked traits”) is both a glyphosate resistant and an insect resistant crop. In a most preferred embodiment of the invention, the crop which exhibits one or more of said resistance mechanisms is a soybean crop. In another most preferred embodiment of the invention, the crop which exhibits one or more of said resistance mechanisms is a corn crop. In another most preferred embodiment of the invention, the crop which exhibits one or more of said resistance mechanisms is a cotton crop.

In another preferred embodiment of the invention, weed control in glyphosate resistant crops, oxynil resistant crops, glufosinate resistant crops, imidazolinone resistant crops, sulfonylurea resistant crops, dicamba tolerant crops, cyclohexanedione resistant crops, PPO resistant crops or HPPD resistant crops, is provided by an application of phenyluracils of formula I or the composition of active ingredients, before the crop is seeded, planted or emerged (pre-emergence or pre-plant application), optionally followed at later timings, when the crop is emerged, by one or more treatments with one or more herbicides which are selective in the crop or to which the crop is resistant, for example, by one or more treatments of glyphosate in case of a glyphosate resistant crop. The weed control according to the present invention can be provided in crops which are resistant to one or more herbicides and/or which are resistant to the attack of fungi and/or which are resistant to the attack of insects, whereby resistance may be conferred by genetic engineering. For example, by said techniques such crops may have acquired the capability to synthesize (i) one or more selectively acting toxins, in particular fungicidal toxins or insecticidal toxins, such as those which are known from toxin producing bacteria, especially those of the genus bacillus, for example endotoxins, e.g. CryIA(b), CryIA(c), CryIF, CryIF(a2), CryIIA(b), CryIIIA, CryIIIB(b1), Cry9c, VIP1, VIP2, VIP3 or VIP3A or hybrids (i.e. combinations of different domains of such toxins), modifications (by replacement of one or more of the amino acids as compared to the naturally occurring sequence, e.g. CryIIIA055) and/or truncated versions thereof, and/or (ii) an altered amount of an enzyme which is the target of a herbicide, and/or (iii) a modified form of an enzyme which is the target of a herbicide, and/or (iv) one or more enzymes which are alone or together capable of converting a herbicide into a chemical which is not toxic to the plant and/or (v) antipathogenic substances, such as, for example, the so-called “pathogenesis-related proteins”. Such crops are illustrated by, but not limited to, the examples described in the following table, which are commercially available or known to the person skilled in the art or described in the quoted publications, and by any other examples which arise from stacking more than one of the traits listed in table 3. Amongst the traits listed in table 3, those are preferred which provide imidazolinone resistance and/or which provide glyphosate resistance and/or which provide insect resistance.

TABLE 3

| | Resistance gene, | | |
|---|---|---|---|
| | event, code no., or | | Reference (see |
| Crop | registered trademark | Resistance | bottom of table) |
| Soybean | A2704-12 | Glufosinate resistant | 1) |
| | | crop | |
| Soybean | A2704-21 | Glufosinate resistant | 1) |
| | | crop | |
| Soybean | A5547-35 | Glufosinate resistant | 1) |
| | | crop | |
| Soybean | A5547-127 | Glufosinate resistant | 1) |
| | | crop | |
| Soybean | GTS-40-3-2 | Glyphosate resistant | 1) |
| | | crop | |
| Soybean | Roundup Ready ® | Glyphosate resistant | 5) |
| | | crop | |
| Soybean | CP4-EPSPS | Glyphosate resistant | 5) |
| | | crop | |
| Soybean | GU262 | Glufosinate resistant | 1) |
| | | crop | |
| Soybean | W62 | Glufosinate resistant | 1) |
| | | crop | |
| Soybean | W98 | Glufosinate resistant | 1) |
| | | crop | |
| Soybean | Dicamba-degrading | Dicamba resistant | 6) |
| | enzymes | crop | |
| Cotton | 15985 | Insect resistant crop | 1) |
| Cotton | 19-51A | Sulfonylurea and/or | 1) |
| | | imidazolinone resistant | |
| | | crop | |
| Cotton | 281-24-236 | Insect resistant crop | 1) |
| Cotton | 3006-210-23 | Insect resistant crop | 1) |
| Cotton | 31807/31808 | Insect and oxynil | 1) |
| | | resistant crop | |
| Cotton | BXN | Oxynil resistant crop | 1) |
| Cotton | LLCotton25 | Glufosinate resistant | 1) |
| | | crop | |
| Cotton | MON1445/1698 | Glyphosate resistant | 1) |
| | | crop | |
| Cotton | MON531/757/1076 | Insect resistant crop | 1) |
| Cotton | NuCOTN 33B ® | Insect resistant crop | 2) |
| Cotton | Bollgard I ® | Insect resistant crop | 2) |
| Cotton | Bollgard II ® | Insect resistant crop | 2) |
| Cotton | VIPCOT ® | Insect resistant crop | 2) |
| Cotton | IPC 531 | Insect resistant crop | 2) |
| Cotton | WideStrike ® | Insect resistant crop | |
| Cotton | WideStrike ® | Glyphosate and insect | |
| | | resistant crop | |
| Cotton | DO-2 | Imidazolinone resistant | 4) |
| | | crop | |
| Cotton | PS-3 | Sulfonylurea resistant | 4) |
| | | crop | |
| Cotton | Roundup Ready ® | Glyphosate resistant | 5) |
| | | crop | |
| Cotton | Roundup Ready ® | Glyphosate resistant | |
| | Flex | crop | |
| Cotton | Roundup Ready ® | Glyphosate and insect | |
| | Flex + Bollgard II ® | resistant crop | |
| Cotton | Roundup Ready ® + | Glyphosate and insect | |
| | Bollgard I ® | resistant crop | |
| Cotton | Roundup Ready ® + | Glyphosate and insect | |
| | Bollgard II ® | resistant crop | |
| Cotton | CP4-EPSPS | Glyphosate resistant | 5) |
| | | crop | |
| Canola | GT200 | Glyphosate resistant | 1) |
| | | crop | |
| Canola | GT73 | Glyphosate resistant | 1) |
| | | crop | |
| Canola | RT73 | Glyphosate resistant | 1) |
| | | crop | |
| Canola | HCN10 | Glufosinate resistant | 1) |
| | | crop | |
| Canola | HCN92 | Glufosinate resistant | 1) |
| | | crop | |
| Canola | MS1 | Glufosinate resistant | 1) |
| | | crop | |
| Canola | RF1 | Glufosinate resistant | 1) |
| | | crop | |
| Canola | PGS1 | Glufosinate resistant | 1) |
| | | crop | |
| Canola | RF2 | Glufosinate resistant | 1) |
| | | crop | |
| Canola | PGS2 | Glufosinate resistant | 1) |
| | | crop | |
| Canola | MS8 × RF3 | Glufosinate resistant | 1) |
| | | crop | |
| Canola | NS738 | Sulfonylurea and/or | 1) |
| | | imidazolinone resistant | |
| | | crop | |
| Canola | NS1471 | Sulfonylurea and/or | 1) |
| | | imidazolinone resistant | |
| | | crop | |
| Canola | NS1473 | Sulfonylurea and/or | 1) |
| | | imidazolinone resistant | |
| | | crop | |
| Canola | OXY-235 | Oxynil resistant crop | 1) |
| Canola | PHY14 | Glufosinate resistant | 1) |
| | | crop | |
| Canola | PHY35 | Glufosinate resistant | 1) |
| | | crop | |
| Canola | PHY36 | Glufosinate resistant | 1) |
| | | crop | |
| Canola | T45 | Glufosinate resistant | 1) |
| | | crop | |
| Canola | HCN28 | Glufosinate resistant | 1) |
| | | crop | |
| Canola | HCR-1 | Glufosinate resistant | 1) |
| | | crop | |
| Canola | ZSR500/502 | Glyphosate resistant | 1) |
| | | crop | |
| Canola | PM1 | Imidazolinone resistant | 4) |
| | | crop | |
| Canola | PM2 | Sulfonylurea and | 4) |
| | | imidazolinone resistant | |
| | | crop | |
| Canola | Clearfield ® | Imidazolinone resistant | 4) |
| | | crop | |
| Flax | FP967 | Sulfonylurea and/or | 1) |
| | | imidazolinone resistant | |
| | | crop | |
| Lentil | RH44 | Sulfonylurea and/or | 1) |
| | | imidazolinone resistant | |
| | | crop | |
| Rice | CL121 | Imidazolinone resistant | 1) |
| | | crop | |
| Rice | CL141 | Imidazolinone resistant | 1) |
| | | crop | |
| Rice | CFX51 | Imidazolinone resistant | 1) |
| | | crop | |
| Rice | LLRICE06 | Glufosinate resistant | 1) |
| | | crop | |
| Rice | LLRICE62 | Glufosinate resistant | 1) |
| | | crop | |
| Rice | PWC16 | Imidazolinone resistant | 1) |
| | | crop | |
| Rice | 93AS3510 | Imidazolinone resistant | 4) |
| | | crop | |
| Rice | Several | Imidazolinone resistant | 4) |
| | | crop | |
| Rice | Clearfield ® | Imidazolinone resistant | 4) |
| | | crop | |
| Rice | CL161 | Imidazolinone resistant | 4) |
| | | crop | |
| Rice | XL8 | Imidazolinone resistant | 4) |
| | | crop | |
| Sugarbeet | GTSB77 | Glyphosate resistant | 1) |
| | | crop | |
| Sugarbeet | H7-1 | Glyphosate resistant | 1) |
| | | crop | |
| Sugarbeet | Roundup Ready ® | Glyphosate resistant | 5) |
| | | crop | |
| Sugarbeet | CP4-EPSPS | Glyphosate resistant | 5) |
| | | crop | |
| Sugarbeet | T120-7 | Glufosinate resistant | 1) |
| | | crop | |
| Sugarbeet | Sir-13 | Imidazolinone resistant | 4) |
| | | crop | |
| Sugarbeet | Sur | Imidazolinone resistant | 4) |
| | | crop | |
| Sugarbeet | 93R30B | Imidazolinone resistant | 4) |
| | | crop | |
| Sunflower | X81359 | Imidazolinone resistant | 1) |
| | | crop | |
| Sunflower | Two | Imidazolinone resistant | 4) |
| | | crop | |
| Sunflower | Clearfield ® | Imidazolinone resistant | 4) |
| | | crop | |
| Sunflower | IMISUN-1 | Imidazolinone resistant | 4) |
| | | crop | |
| Sunflower | IMISUN-2 | Imidazolinone resistant | 4) |
| | | crop | |
| Tobacco | C/F/93/08-02 | Oxynil resistant crop | 1) |
| Tobacco | KS-43 | Sulfonylurea and | 4) |
| | | imidazolinone resistant | |
| | | crop | |
| Wheat | AP205CL | Imidazolinone resistant | 1) |
| | | crop | |
| Wheat | AP602CL | Imidazolinone resistant | 1) |
| | | crop | |
| Wheat | MON71800 | Glyphosate resistant | 1) |
| | | crop | |
| Wheat | SWP965001 | Imidazolinone resistant | 1) |
| | | crop | |
| Wheat | Teal 11A, TealIMI | Imidazolinone resistant | 1), 4) |
| | 11A | crop | |
| Wheat | Several | Imidazolinone resistant | 4) |
| | | crop | |
| Wheat | Clearfield ® | Imidazolinone resistant | 4) |
| | | crop | |
| Wheat | FS1 | Imidazolinone resistant | 4) |
| | | crop | |
| Wheat | FS2 | Imidazolinone resistant | 4) |
| | | crop | |
| Wheat | FS3 | Imidazolinone resistant | 4) |
| | | crop | |
| Wheat | FS4 | Imidazolinone resistant | 4) |
| | | crop | |
| Corn | 176 | Insect resistant crop | 1) |
| Corn | 3751IR | Imidazolinone resistant | 1) |
| | | crop | |
| Corn | 676 | Glufosinate resistant | 1) |
| | | crop | |
| Corn | 678 | Glufosinate resistant | 1) |
| | | crop | |
| Corn | 680 | Glufosinate resistant | 1) |
| | | crop | |
| Corn | B16 (DLL25) | Glufosinate resistant | 1) |
| | | crop | |
| Corn | BT11 (X4334CBR, | Insect and glufosinate | 1), 2) |
| | X4734CBR) | resistant crop | |
| Corn | CBH-351 | Insect and glufosinate | 1) |
| | | resistant crop | |
| Corn | DAS-06275-8 | Insect and glufosinate | 1) |
| | | resistant crop | |
| Corn | DBT418 | Insect and glufosinate | 1) |
| | | resistant crop | |
| Corn | DK404SR | Cyclohexanedione | 1) |
| | | resistant crop | |
| Corn | EXP1910IT | Imidazolinone resistant | 1) |
| | | crop | |
| Corn | GA21 | Glyphosate resistant | 1), 5) |
| | | crop | |
| Corn | IT | Imidazolinone resistant | 1) |
| | | crop | |
| Corn | MON80100 | Insect resistant crop | 1) |
| Corn | MON802 | Insect and glyphosate | 1) |
| | | resistant | |
| | | crop | |
| Corn | MON809 | Insect and glyphosate | 1) |
| | | resistant | |
| | | crop | |
| Corn | MON810 | Insect resistant crop | 1) |
| Corn | MON832 | Glyphosate resistant | 1) |
| | | crop | |
| Corn | MON863 | Insect resistant crop | 1) |
| Corn | MS3 | Glufosinate resistant | 1) |
| | | crop | |
| Corn | MS6 | Glufosinate resistant | 1) |
| | | crop | |
| Corn | NK603 | Glyphosate resistant | 1) |
| | | crop | |
| Corn | T14 | Glufosinate resistant | 1) |
| | | crop | |
| Corn | T25 | Glufosinate resistant | 1) |
| | | crop | |
| Corn | TC1507, 1507 | Insect and glufosinate | 1), 2) |
| | | resistant crop | |
| Corn | YieldGard ® | Insect resistant crop | 2) |
| Corn | YieldGard ® Corn | Insect resistant crop | |
| | borer | | |
| Corn | YieldGard ® Root- | Insect resistant crop | 2) |
| | worm | | |
| Corn | YieldGard Plus ® | Insect resistant crop | 2) |
| Corn | Starlink ® | Insect resistant crop | 2) |
| Corn | Herculex I ® | Insect and Glufosinate | 2) |
| | | resistant crop | |
| Corn | Herculex RW ® | Insect resistant crop | |
| Corn | Herculex XTRA ® | Insect resistant crop | |
| Corn | Bt176 | Insect and glufosinate | 2) |
| | | resistant crop | |
| Corn | MIR604 | Insect resistant crop | 2) |
| Corn | NK 603 × MON 810 | Insect and glyphosate | 2) |
| | | resistant | |
| | | crop | |
| Corn | XI12 | Imidazolinone resistant | 4) |
| | | crop | |
| Corn | QJ22 | Imidazolinone resistant | 4) |
| | | crop | |
| Corn | Mutant 2 | Imidazolinone resistant | 4) |
| | | crop | |
| Corn | XA17 | Imidazolinone resistant | 4) |
| | | crop | |
| Corn | ICI 8532 IT | Sulfonylurea and | 4) |
| | | imidazolinone resistant | |
| | | crop | |
| Corn | Mutant 1 | Imidazolinone resistant | 4) |
| | | crop | |
| Corn | Clearfield ® | Imidazolinone resistant | 4) |
| | | crop | |
| Corn | Roundup Ready ® | Glyphosate resistant | 5) |
| | | crop | |
| Corn | Roundup Ready ® + | Glyphosate and insect | |
| | YieldGard ® Corn | resistant crop | |
| | borer | | |
| Corn | Roundup Ready ® + | Glyphosate and insect | |
| | YieldGard ® Root- | resistant crop | |
| | worm | | |
| Corn | CP4-EPSPS | Glyphosate resistant | 5) |
| | | crop | |
| Corn; others (see | Acuron ®; others (see | PPO resistant crop | 3) |
| ref. 3) | ref. 3) | | |
| Any | Dicamba-degrading | Dicamba resistant | 6) |
| | enzymes | crop | |
| Any | HPPD resistance | HPPD resistant crop | 7) |
| | genes | | |
| Any | — | Fungus resistant | e.g. 2) and references |
| | | plants | quoted |
| | | | therein (EP |
| | | | 392225, WO |
| | | | 95/33818, EP |
| | | | 353191, WO |
| | | | 03/00906) |

1) http://www.agbios.com/dbase.php#
2) WO 05/13696
3) X. Li, D. Nicholl, Pest Manag. Sci. 2005, 61, 277-285 and references cited therein; WO 95/34659, WO 97/32011, WO 97/32028, WO 01/12825
4) S. Tan, R. Evans, M. Dahmer, B. Singh, D. Shaner, Pest Manag. Sci. 2005, 61, 246-257 and references cited therein
5) G. Dill, Pest Manag. Sci. 2005, 61, 219-224 and references cited therein; W. Pline-Srnic, Pest Manag. Sci. 2005, 61, 225-234 and references cited therein
6) WO 98/45424; WO 02/68607
7) M. Matringe, A. Sailland, B. Pelissier, A. Rolland, O. Zink, Pest Manag. Sci, 2005, 61, 269-276 and references cited therein; WO 96/38567; WO 98/04685; WO 99/24585; WO 99/25842

The following examples illustrate the invention without limiting it.

The effect of the use of phenyluracils I or mixtures thereof according to the present invention on the growth of crop plants and/or undesired plants was demonstrated by field tests (examples 1-6).

The phenyluracils I and/or the other active ingredients according to the present invention were formulated in a suitable way, either separately or in mixture, e.g. as emulsifiable concentrates (EC), soluble concentrates (SL), suspo-emulsions (SE), suspension concentrates (SC) or water-dispersible granules (WG). The formulation(s) were suspended or emulsified in water as a distribution medium immediately prior to spraying. Afterwards, the aqueous mixture was evenly sprayed on the test plots by means of finely distributing nozzles.

The test plots were of uniform size (typically between 14 and 37 square meters, each) and the distribution of treated and untreated plots was organized according to a randomised bloc design. Crops were sown in rows at a season which was typical for the region and the crop according to usual farm practice. Weeds were not sown but germinated according to the natural infestation.

For pre-plant and pre-plant burn-down treatments, the plots were treated before the crop was planted, typically 7 to 28 days prior to planting. For pre-emergence treatments, the plots were treated at planting (plus or minus two days) but before emergence. For post-emergence or in-crop treatments, the plots were treated after the emergence of the weed or crop, typically 20 to 50 days after planting.

The evaluation of the damage caused by the phenyluracils I and/or the other active ingredients according to the present invention was carried out using a scale from 0 to 100%, compared to the untreated control plots. Here, 0 means no damage and 100 means complete destruction of the plants of a respective weed or crop species.

### EXAMPLE 1

Weed control in glyphosate resistant soybeans 44 days after treatment; pre-plant treatment; field test.

The results are given in the following table 4.

TABLE 4

| | | Phytotoxicity in | Weed control | |
|---|---|---|---|---|
| | | glyphosate | (% control) | |
| | | resistant | | Giant |
| | Use rate | soybeans | Velvetleaf | ragweed |
| Active ingredient | (g/ha) | (% damage) | (ABUTH) | (AMBTR) |
| Glyphosate | 870 | 0 | 17 | 86 |
| Phenyluracil I.7 | 25 | 0 | 92 | 89 |
| Phenyluracil I.7 + | 25 + 870 | 0 | 95 | 97 |
| glyphosate | | | | |
| Phenyluracil I.7 + | 25 + 70 | 0 | 98 | 97 |
| imazethapyr | | | | |

In this example, glyphosate (potassium salt) was formulated as a 540 g/l SL, phenyluracil I.7 as a 120 g/l EC, and imazethapyr (ammonium salt) as a 240 g/l SL. Prior to application, the formulated active ingredients were tank-mixed with an aqueous 140 l/ha spray solution which contained, in addition, 20 g/l of ammonium sulphate and 10 g/l of Agridex. The soybean crop was planted at 15 DAT.

### EXAMPLE 2

Weed control in glyphosate resistant soybeans 86 days after the first treatment; pre-plant burn-down treatment followed by an in-crop glyphosate treatment at 53 DAT; field test.

The results are given in the following table 5.

TABLE 5

| | | Phytotoxicity | Weed control (% control) | | |
|---|---|---|---|---|---|
| | | in glyphosate | | Giant rag- | Common |
| Active ingre- | | resistant soybeans | Velvetleaf | weed | lambsquarters |
| dient | Use rate | (% damage) | (ABUTH) | (AMBTR) | (CHEAL) |
| Glyphosate, | 870 g/ha, | 0 | 91 | 86 | 89 |
| followed by | followed by | | | | |
| another gly- | 870 g/ha at | | | | |
| phosate | 53 DAT | | | | |
| treatment at | | | | | |
| 53 DAT | | | | | |
| Phenyluracil | 50 g/ha, | 0 | 97 | 97 | 99 |
| I.7, followed | followed by | | | | |
| by a gly- | 870 g/ha at | | | | |
| phosate | 53 DAT | | | | |
| treatment at | | | | | |
| 53 DAT | | | | | |

In this example, glyphosate (potassium salt) was formulated as a 540 g/l SL and phenyluracil I.7 as a 120 g/l EC. Prior to application, the formulated active ingredients were tank-mixed with an aqueous 140 l/ha spray solution which contained, in addition, 68 g/l of ammonium sulphate in case of glyphosate and 10 g/l of oil concentrate in case of phenyluracil I.7. The soybean crop was planted at 8 DAT.

### EXAMPLE 3

Weed control in glyphosate resistant soybeans 57 days after the first treatment; pre-plant treatment followed by an in-crop glyphosate treatment at 42 DAT; field test.

The results are given in the following table 6.

TABLE 6

| | | Phytotoxicity in | Weed control (% control) | |
|---|---|---|---|---|
| | | Glyphosate resistant | Common lamb- | Giant |
| | | soybeans | squarters | ragweed |
| Active ingredient | Use rate | (% damage) | (CHEAL) | (AMBTR) |
| Glyphosate, | 870 g/ha, followed | 0 | 83 | 72 |
| followed by another | by 870 g/ha | | | |
| glyphosate | at 42 DAT | | | |
| treatment at 42 | | | | |
| DAT | | | | |
| Phenyluracil I.7, | 25 g/ha, followed | 0 | 97 | 95 |
| followed by a | by 870 g/ha | | | |
| glyphosate | at 42 DAT | | | |
| treatment at 42 | | | | |
| DAT | | | | |
| Phenyluracil I.7 + | 25 + 870 g/ha, | 0 | 99 | 96 |
| glyphosate, | followed by 870 g/ha | | | |
| followed by a | at 42 DAT | | | |
| glyphosate | | | | |
| treatment at 42 | | | | |
| DAT | | | | |
| Phenyluracil I.7 + | 25 + 70 g/ha, | 0 | 96 | 94 |
| imazethapyr, | followed by 870 g/ha | | | |
| followed by a | at 42 DAT | | | |
| glyphosate | | | | |
| treatment at 42 | | | | |
| DAT | | | | |

In this example, glyphosate (potassium salt) was formulated as a 540 g/l SL, phenyluracil I.7 as a 120 g/l EC, and imazethapyr (ammonium salt) as a 240 g/l SL. Prior to application, the formulated active ingredients were tank-mixed with an aqueous 140 l/ha spray solution which contained, in addition, 20 g/l of ammonium sulphate. The soybean crop was planted at 12 DAT.

### EXAMPLE 4

Weed control in glyphosate resistant corn 59 days after treatment; pre-emergence treatment; field test.

The results are given in the following table 7.

TABLE 7

| | | Phytotoxicity | Weed control | |
|---|---|---|---|---|
| | | in glyphosate | (% control) | |
| | | resistant | | Amaranthus |
| | Use rate | corn (% | Velvetleaf | tamariscinus |
| Active ingredient | (g/ha) | damage) | (ABUTH) | (AMATA) |
| Atrazine + | 1617 + 833 | 0 | 75 | 100 |
| dimethenamid-P | | | | |
| Phenyluracil I.7 + | 75 + 750 | 0 | 97 | 100 |
| dimethenamid-P | | | | |

In this example, atrazine (396 g/l) and dimethenamid-P (204 g/l) were co-formulated as an SE. Phenyluracil 1.7 (48 g/l) and dimethenamid-P (480 g/l) were co-formulated as an EC. Prior to application, the formulated active ingredients were tank-mixed with an aqueous 187 l/ha spray solution. The corn crop was planted at 0 DAT.

### EXAMPLE 5

Weed control in glyphosate resistant corn 59 days after the first treatment; pre-emergence treatment followed by an in-crop glyphosate treatment at 49 DAT; field test.

The results are given in the following table 8.

TABLE 8

| | | | Weed control (% control) | |
|---|---|---|---|---|
| | | Phytotoxicity in | | Amaranthus |
| | | glyphosate resistant | Velvetleaf | tamariscinus |
| Active ingredient | Use rate | corn (% damage) | (ABUTH) | (AMATA) |
| Atrazine + acetochlor, | 629 + 1591 g/ha, | 0 | 63 | 100 |
| followed | followed | | | |
| by a glyphosate | by 870 g/ha at | | | |
| treatment at 49 | 49 DAT | | | |
| DAT | | | | |
| Phenyluracil I.7 + | 50 + 500 g/ha, | 0 | 93 | 100 |
| dimethenamid- | followed by | | | |
| P, followed by a | 870 g/ha at 49 | | | |
| glyphosate | DAT | | | |
| treatment at 49 | | | | |
| DAT | | | | |

In this example, glyphosate (potassium salt) was formulated as a 540 g/l SL. Acetochlor (516 g/l) and atrazine (204 g/l) were co-formulated as an SC. Phenyluracil 1.7 (60 g/l) and dimethenamid-P (600 g/l) were co-formulated as an EC. Prior to application, the formulated active ingredients were tank-mixed with an aqueous 187 l/ha spray solution which contained, in addition, in case of glyphosate, 20 g/l of ammonium sulphate. The corn crop was planted at 0 DAT.

### EXAMPLE 6

Weed control in glyphosate resistant corn 35 days after treatment; pre-emergence treatment; field test.

The results are given in the following table 9.

TABLE 9

| | | Phytotoxicity | Weed control | |
|---|---|---|---|---|
| | | in glyphosate | (% control) | |
| | | resistant | | Giant |
| | Use rate | corn (% | Velvetleaf | ragweed |
| Active ingredient | (g/ha) | damage) | (ABUTH) | (AMBTR) |
| Atrazine + | 2125 + 1095 | 0 | 68 | 47 |
| dimethenamid-P | | | | |
| Atrazine + | 722 + 1828 | 0 | 73 | 63 |
| acetochlor | | | | |
| Phenyluracil I.7 + | 50 + 500 | 0 | 98 | 92 |
| dimethenamid-P | | | | |

In this example, acetochlor (516 g/l) and atrazine (204 g/l) were co-formulated as an SC. Phenyluracil 1.7 (60 g/l) and dimethenamid-P (600 g/l) were co-formulated as an EC. Atrazine (396 g/l) and dimethenamid-P (204 g/l) were co-formulated as an SE. Prior to application, the formulated active ingredients were tank-mixed with an aqueous 140 l/ha spray solution. The corn crop was planted 1 day before treatment.

1-23. (canceled)

24. A method of controlling weeds in crops selected from the group consisting of soy bean, cotton, canola, flax, lentil, rice, sugar beet, sunflowers, tobacco, wheat and corn, wherein the method comprises applying a herbicidally effective amount of a 3-phenyluracil of formula I 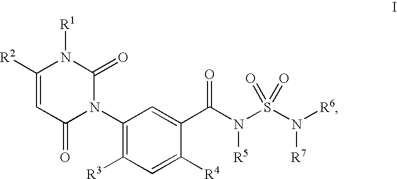
wherein:
is methyl or NH₂;
is C₁-C₂-haloalkyl;
is hydrogen or halogen;
is halogen or cyano;
R⁵ is hydrogen or C₁-C₆-alkyl;
R⁶, R⁷ independently of one another are hydrogen, C₁-C₆-alkyl, C₁-C₆-alkoxy, C₃-C₆-alkenyl, C₃-C₆-alkynyl, C₃-C₇-cycloalkyl, C₃-C₇-cycloalkenyl, phenyl or benzyl;
or an agriculturally acceptable salt thereof to the crops or weeds or the habitat of the crops or weeds.

25. The method of claim 24, wherein:
R¹ is methyl or NH₂;
R² is trifluoromethyl;
R³ is hydrogen, fluorine or chlorine;
R⁴ is halogen or cyano;
R⁵ is hydrogen;
R⁶, R⁷ independently of one another are hydrogen, C₁-C₆-alkyl, C₃-C₆-alkenyl, C₃-C₆-alkynyl, C₃-C₇-cycloalkyl, C₃-C₇-cycloalkenyl, phenyl or benzyl.

26. The method of claim 24, wherein R⁶ and R⁷ in formula I are identical or different C₁-C₆-alkyl radicals.

27. The method of claim 24, wherein the crop is selected from the group consisting of corn and soybeans.

28. The method of claim 24, wherein the crop is a herbicide resistant and/or insect resistant and/or fungus resistant crop.

29. The method of claim 28, wherein the crop is selected from glyphosate resistant crops.

30. The method of claim 28, wherein the crop is selected from imidazolinone resistant crops.

31. The method of claim 28, wherein the crop is selected from insect resistant crops.

32. The method of claim 24, wherein the 3-phenyluracil of formula I is used in combination with one or more other herbicides B or agriculturally acceptable salts thereof.

33. The method of claim 32, wherein the other herbicide B is selected from herbicides of the following classes b1) to b15) having acarboxyl group or an agriculturally acceptable salt or derivative thereof:
b1) lipid biosynthesis inhibitors;
b2) acetolactate synthase inhibitors (ALS inhibitors);
b3) photosynthesis inhibitors;
b4) protoporphyrinogen-IX oxidase inhibitors;
b5) bleacher herbicides;
b6) enolpyruvyl shikimate 3-phosphate synthase inhibitors (EPSP inhibitors);
b7) glutamine synthetase inhibitors;
b8) 7,8-dihydropteroate synthase inhibitors (DHP inhibitors);
b9) mitose inhibitors;
b11) inhibitors of the synthesis of long chain fatty acids (VLCFA inhibitors);
b12) cellulose biosynthesis inhibitors;
b13) decoupler herbicides;
b14) auxin transport inhibitors;
b15) other herbicides selected from the group consisting of benzoylprop, flamprop, flamprop-M, bromobutide, chlorflurenol, cinmethylin, methyldymuron, etobenzanid, fosamine, metam, pyributicarb, oxaziclomefone, dazomet, triaziflam and methyl bromide.

34. The method of claim 32, wherein the 3-phenyluracil of formula I is used in combination with glyphosate or an agriculturally acceptable salt thereof.

35. The method of claim 34, wherein the 3-phenyluracil of formula I is used in combination with glyphosate and one or more other herbicides B or agriculturally acceptable salts thereof.

36. The method of claim 32, wherein the 3-phenyluracil of formula I is used in combination with a herbicide B selected from imazamethabenz, imazamox, imazapyr, imazaquin and imazethaypr or an agriculturally acceptable salt thereof.

37. The method of claim 36, wherein the 3-phenyluracil of formula I is used in combination with imazamethabenz, imazamox, imazapyr, imazaquin or imazethaypr and one or more other herbicides B or agriculturally acceptable salts thereof.

38. The method of claim 32, wherein the other herbicide B is selected from the group consisting of acetochlor, atrazine, (S)-metolachlor, alachlor, flufenacet, mesotrione, isoxaflutole, pendimethalin, sulfentrazone, chlorimuron, trifluralin, imazepthapyr, imazaquin, paraquat, dimethenamid, dimethenamid-P, metribuzin; and
the agriculturally acceptable salts thereof.

39. The method of claim 35, wherein the other herbicide B is selected from the group consisting of acetochlor, atrazine, (S)-metolachlor, alachlor, flufenacet, mesotrione, isoxaflutole, pendimethalin, sulfentrazone, chlorimuron, trifluralin, imazepthapyr, imazaquin, paraquat, dimethenamid, dimethenamid-P, metribuzin; and
the agriculturally acceptable salts thereof.

40. The method of claim 37, wherein the other herbicide B is selected from the group consisting of acetochlor, atrazine, (S)-metolachlor, alachlor, flufenacet, mesotrione, isoxaflutole, pendimethalin, sulfentrazone, chlorimuron, trifluralin, imazepthapyr, imazaquin, paraquat, dimethenamid, dimethenamid-P, metribuzin; and
the agriculturally acceptable salts thereof.

41. The method of claim 38, wherein the other herbicide B is selected from the group consisting of imazethapyr, dimethenamid, dimethenamid-P; and the agriculturally acceptable salts thereof.

42. The method of claim 39, wherein the other herbicide B is selected from the group consisting of imazethapyr, dimethenamid, dimethenamid-P; and the agriculturally acceptable salts thereof.

43. The method of claim 40, wherein the other herbicide B is selected from the group consisting of imazethapyr, dimethenamid, dimethenamid-P; and the agriculturally acceptable salts thereof.

44. The method of claim 24, wherein the 3-phenyluracil of formula I is used in combination with one or more safeners C or agriculturally acceptable salts thereof.

45. The method of claim 24, wherein the 3-phenyluracil is optionally applied in combination with one or more other herbicide B and/or optionally in combination with one or more safener C is applied pre-plant up to pre-emergence.

46. The method of claim 24, wherein the 3-phenyluracil is applied pre-plant or pre-emergence followed by one or more treatments with one or more other herbicides B post-emergence.
